(19) United States
(12) Patent Application Publication
(10) Pub. No.: US 2026/0370479 A1
(43) Pub. Date: Nov. 19, 2026

(54) DISTRIBUTED DATABASE STRUCTURES FOR ANONYMOUS INFORMATION EXCHANGE

(71) Applicant: CIRCULARISE B.V., BH Den Haag (NL)

(72) Inventors: Dewi-Tim DAVIES, BH Den Haag (NL); Sharif Elias JACOBINO, BH Den Haag (NL); Rudi Nelson NUNES ARAÚJO, BH Den Haag (NL); Mesbah SABUR, Doetinchem (NL); Jordi Robert DE VOS, Rijswijk (NL); Syed Nabil AHMED, BH Den Haag (NL)

(21) Appl. No.: 19/545,589

(22) Filed: Feb. 20, 2026

Related U.S. Application Data
(63) Continuation of application No. PCT/IB2024/000510, filed on Sep. 11, 2024.
(60) Provisional application No. 63/538,411, filed on Sep. 14, 2023.

(51) Int. Cl. H04L 9/32; G06F 21/62; H04L 9/00

(52) U.S. Cl. CPC H04L 9/3218; G06F 21/6254; H04L 9/50

(57) ABSTRACT

Present disclosure provides systems and methods for managing and verifying information via blockchain. The method comprises: generating, by a user node, a cryptographic state commitment associated with a state of the user node; storing, at the user node, the state of the user node, wherein the state of the user node comprises data associated with one or more claims causing an update of the state and wherein the data is not shared publicly; constructing, by the user node, zero-knowledge proofs (zk-SNARKs) that attest to a validity of the update of the state without revealing the data; and broadcasting to a blockchain the zero-knowledge proofs and the cryptographic state commitment, wherein the zero-knowledge proofs ensure a validity of the state of the user node on the blockchain.

### CROSS-REFERENCE

This application is a continuation of International Application No. PCT/IB2024/000510 filed on Sep. 11, 2024, which claims priority to U.S. Provisional Application No. 63/538,411 filed on Sep. 14, 2023, which is incorporated by reference herein in its entirety.

### BACKGROUND

Existing systems for producing verifiable sustainability claims typically rely on either full transparency, or appeal to privileged authorities to provide evidence for the legitimacy of said claims. Alternatively they attempt a weaker, more traditional notion of verifiability, in which, rather than auditing the basis of the claims, the user is given a non-repudiable, signed version of the claims, guaranteeing its authenticity only without guaranteeing its integrity.

### SUMMARY

Existing systems and methods lack the ability to provide a high level of assurance to consumers about the veracity of sustainability claims made for products. Current methods may inadequately provide consumers with the ability to effectively investigate product claims and have confidence in the accuracy of these claims. There is also a gap in providing satisfactory answers to consumers' further queries about the product, backed by substantial documentation. In essence, an unaddressed need exists for a full, customer-facing audit to support every sustainability claim. There may exist an inherent level of information imbalance between consumers and entities within the supply chain in order to foster competition.

Acknowledging the existing challenges, a solution may involve envisioning a scenario where a single, reliable, and trustworthy authority exists. Every participant in the supply chain may submit their documents, records, and certifications to this authority. This authority may be capable of creating a global understanding of the interconnections in these documents, comprehensively overseeing the operations of the participating members. The authority may also trace the audit trail, assess the feasibility of the operations, confirm compliance with established standards, and ensure consistency with certifications and physical assessments. Moreover, the authority may be alerted to any new documents that contradict previous data. From this, the authority may attest to any product claim at any granularity level. As a result, consumers may be more confident in buying products that align with their ethical beliefs, and manufacturers may be rewarded for sustainable practices. However, in reality, such a perfect, incorruptible authority may be unlikely to exist.

The present disclosure addresses the above needs by providing systems and methods for producing cryptographically verifiable claims over knowledge graphs that are economically and computationally feasible. This may be achieved by creating a system that enhances transparency through thorough, consumer-facing audits. Such a system may address the need for complete, consumer-facing audits for every sustainability claim, while maintaining a necessary level of information asymmetry to foster competition within the supply chain.

The present disclosure provides systems and methods that may produce cryptographically verifiable claims over knowledge graphs. The system and methods may facilitate collaboration, confidentiality, and consistency. The system and methods may allow multiple parties in the supply chain to make and coordinate attestations, and may foster collaboration by decreasing reliance on the end actor or a global authority as compared to traditional systems and methods, without necessarily revealing the participants' identities. Confidentiality may be preserved as the system may enable attestations without the necessity of revealing the underlying records. Furthermore, the system may support consistency by making attestations tamper-evident and allowing for the possibility to verify these attestations' consistency relative to the underlying records, again without revealing them.

The system may facilitate the creation of pseudonymised knowledge graphs, centered around a specific subject. The knowledge graphs may be employed to develop derived claims about that subject or other subjects within the knowledge graphs, based on their relationship to the root subject. The knowledge graphs may comprise claims that are substantiated cumulatively by a subgraph and may limit the revelation of information to only what is necessary.

In an aspect, disclosed herein is a computer-implemented method for producing and sharing verifiable information while preserving anonymity and privacy. The method comprises: creating, by a user at a user node, one or more claims about a subject, wherein the one or more claims are constrained by a constraint system associated with the subject; updating, at the user node, a state related to the user node or a user account based on the one or more claims, wherein the state related to the user node or the user account comprises private data that is stored on the user node and not shared publicly; updating or creating a cryptographic state commitment for validating proofs of the updated state, wherein the cryptographic state commitment is associated pseudonymously or anonymously with the user and is recorded on a blockchain, and wherein validating proofs of the updated state comprises proofing that updating the state is a valid state transition from a previous state or proofing a validity of the one or more claims about the state underlying the cryptographic state commitment; and constructing a Zero-Knowledge proof that attests to a validity of the updated state without revealing the state.

In a related yet separate aspect, disclosed herein is a system for producing and sharing verifiable information while preserving anonymity and privacy. The system comprises: a processor; and memory including executable instructions that, as a result of being executed by the processor, causes the system to perform operations comprising: creating, by a user at a user node, one or more claims about a subject, wherein the one or more claims are constrained by a constraint system associated with the subject; updating, at the user node, a state related to the user node or a user account based on the one or more claims, wherein the state related to the user node or the user account comprises private data that is stored on the user node and not shared publicly; updating or creating a cryptographic state commitment for validating proofs of the updated state, wherein the cryptographic state commitment is associated pseudonymously or anonymously with the user and is recorded on a blockchain, and wherein validating proofs of the updated state comprises proofing that updating the state is a valid state transition from a previous state or proofing a validity of the one or more claims about the state underlying the cryptographic state commitment; and constructing a Zero-Knowledge proof that attests to a validity of the updated state without revealing the state.

In some embodiments, the constraint system is a framework comprising one or more predefined rules constraining a formal expression of the one or more claims. In some embodiments, the one or more claims comprise a collaborative inductive claim. In some cases, the collaborative inductive claim references one or more other claims. In some instances, the one or more other claims are created by another user. In some instances, the one or more other claims are verified by the user node against a cryptographic state commitment associated with the another user that is recorded on the blockchain. In some instances, the one or more referenced claims are predicates over a process by which the one or more claims were created and/or metadata.

In some embodiments, the Zero-Knowledge proof is zero-knowledge succinct non-interactive arguments of knowledge (zk-SNARKs). In some embodiments, the blockchain is a public blockchain.

In some embodiments, the cryptographic state commitment associated with the user on the blockchain is stored utilizing an authenticated data structure. In some cases, the cryptographic state commitment associated with the user is identified by an index of a leaf node of a Merkle Tree. In some instances, updating the cryptographic state commitment associated with the user comprises maintaining a root commitment mapping using the Merkle tree or a cryptographic accumulator. In some examples, the root commitment is used as an input to a proof for publicly verifying the one or more claims created by the user and the updated state. In some cases, the user is identified by a key in an indexed Merkle Tree or by a key of the authenticated data structure implementing a map structure.

In some embodiments, the one or more claims about the subject are verifiable by verifying an authenticity or a compliance with the constraint system. In some embodiments, the Zero-Knowledge proof ensures a claim adheres to a predetermined rule and a previous state.

In some embodiments, the one or more claims about the subject are in the form of entries of a record. In some cases, the entries store information about one or more attributes of the subject. In some instances, the one or more attributes are defined by one or more predefined rules of the constraint system. For example, the one or more attributes are constrained by a forward propagation of predicates through an attribute definition Directed Acyclic Graph (DAG). In another example, the one or more attributes are constrained by propagation of constraints through a dependency DAG.

In yet another aspect, disclosed herein is a computer-implemented method for managing and verifying information via blockchain. The method comprises: generating, by a user node, a cryptographic state commitment associated with a state of the user node; storing, at the user node, the state of the user node, wherein the state of the user node comprises data associated with one or more claims causing an update of the state and wherein the data is not shared publicly; constructing, by the user node, zero-knowledge proofs (zk-SNARKs) that attest to a validity of the update of the state without revealing the data; and broadcasting to a blockchain the zero-knowledge proofs and the cryptographic state commitment, wherein the zero-knowledge proofs ensure a validity of the state of the user node on the blockchain.

In some embodiments, the method further comprises creating, by the user node, another cryptographic state commitment for the updated state. In some cases, the method further comprises publishing another cryptographic state commitment on the blockchain to serve as verifiable and non-reversible records accessible via the blockchain.

In some embodiments, the state of the user node further comprises data about a collaborative inductive claim. In some cases, the collaborative inductive claim references one or more other claims. In some instances, the one or more other claims are created by another user.

In some embodiments, the state of the user node further comprises metadata about the one or more claims, one or more previous claims, and the validity or invalidity of an update of the state. In some embodiments, the state of the user node further comprises auxiliary data for creating the zero-knowledge proofs. In some cases, the auxiliary data comprises intermediate nodes of authenticated data structures.

In some embodiments, the cryptographic state commitment is stored on the blockchain utilizing an authenticated data structure. In some embodiments, the method further comprises updating at least a part of a global state commitment agreed upon by a consensus protocol of the blockchain upon publishing the cryptographic state commitment to the blockchain. In some cases, a state commitment associated with a given user or given user node is associated with all records for all frameworks associated with the given user. In some instances, the global state comprises all state commitments associated with all users or all user nodes of a network are published on the blockchain. In some examples, attesting to the validity of the update of the state comprises determining whether the one or more claims are valid. In some examples, determining the one or more claims are valid when the one or more claims are consistent with the global state commitments without relying on an identity of user or source of record thereby avoiding revealing a relationship between users.

In some embodiments, the method further comprises verifying the zero-knowledge proofs that the update of the state is a result of valid transaction according to a global rule and a previous state commitment. In some embodiments, the cryptographic state commitment encodes metadata about a predefined framework rule constraining a formal expression of the one or more claims.

In some embodiments, the one or more claims are stored in one or more entries of a record. In some cases, the record is associated with a subject and the one or more entries are associated with one or more attributes of the subject. In some instances, the method further comprises implementing a UTXO-like model or balance log via mutual referencing between records to enforce consistency between the records or to constrain a multiplicity of relationships. For example, the mutual referencing is enforced according to a constraint system. In some examples, a constraint of the constraint system enforces the mutual referencing on a relationship between attributes of referenced records from the plurality of the records.

In some embodiments, the method further comprises verifying a staleness status or a validity status of the one or more claims based at least in part on a time threshold. In some embodiments, at least one claim is a relative claim about a second subject based on a claim about a first subject. In some cases, the relative claim is verified based on a relationship between the first subject and the second subject without relying on identities of the first and second subjects. In some cases, the update of the state comprises modifying or updating a state of an entry of a record, and the updated state of the entry is used to determine an invalidity of a dependent entry based on a potential contradiction to the updated entry.

In some embodiments, the update of the state comprises modifying or updating the one or more claims and determining an invalidity of a dependent claim based on a potential contradiction between the dependent claim and the updated one or more claims. In some embodiments, the state of the user node further comprises data associated with a claim or state of another user node that is in a transaction with the user node. In some cases, the claim or state of another user node is used to derive an inductive claim consistent with the claim or the state via a recursive zk-SNARKs. In some cases, the inductive claim is stored on the user node and not published on the blockchain.

In some embodiments, the blockchain is a succinct blockchain and a global state of the blockchain is validated via a single proof. In some cases, all state updates in a given block or the blockchain are recursively aggregated into the single proof.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows an example of a global execution environment implementing methods and systems herein, in accordance with some embodiments.

FIG. 2 shows an example of a dependency graph of a collaborative inductive claim.

FIG. 3 shows an example of Entries in a Record within the system, representing the totality of claims about a subject Record, in accordance with some embodiments.

FIG. 4 shows an example of how Disclosures, which are selectively disclosed Entries, function within the system, in accordance with some embodiments.

FIG. 5 shows an example of how Entries are created transactionally according to rules dependent on the record state and global state, as specified by the transaction methods of a Framework, in accordance with some embodiments.

FIG. 6 shows an example of Entries as claims about an Attribute of a subject Record, and Disclosures, as predicates over an Attribute constrained by its respective Entry, are structured within a Record in the system, in accordance with some embodiments.

FIG. 7 shows an example of how Entries, as assertions about Attributes of a subject Record, and Disclosures, as predicates over Attributes constrained by Entries, are structured within a Record and its associated Entries, in accordance with some embodiments.

FIG. 8A shows an example of Records as collections of versioned Entries.

FIG. 8B shows an example of Records as versioned collections of Entries.

FIG. 8C shows an example of Records as version collections of references to Entries

FIG. 9 shows an example of implementation of Unspent Transaction Output (UTXO)-like spending using the mutual referencing pattern within the system.

FIG. 10 shows an example of implementing spending rules that update the remaining amount of an asset using the mutual referencing pattern within the system.

FIG. 11 schematically illustrates an example of logs of records with indexing using the mutual referencing pattern within the system.

FIG. 12 shows an example of a state update process in the user state root mapping approach within the system.

FIG. 13 shows an example of a structure of User State Commitments in a ZCash-like model within the system.

FIG. 14 shows an example of an augmented version of the model depicted in FIG. 12.

FIG. 15 shows an example of a simplified banking system illustrating the concept of state changes due to transactions within the system, in accordance with some embodiments.

FIG. 16 shows an example of a proof that illustrates a state transition from State 1 to State 2 as a result of executing a specific transaction, in accordance with some embodiments.

FIG. 17 shows an example of a User States Root within the system, providing a graphical representation of how user states are structured, in accordance with some embodiments.

FIG. 18 shows a non-limiting example of a computing device implementing methods and systems herein.

### DETAILED DESCRIPTION

The present disclosure provides improved systems and methods for producing and sharing verifiable information while preserving anonymity and privacy, comprising: creating, by a user at a user node, one or more claims about a subject. In some embodiments, the one or more claims are constrained by a constraint system associated with the subject. In some embodiments, the method comprises updating, at the user node, a state related to the user node or a user account based on the one or more claims. In some embodiments, the state related to the user node or the user account comprises private data that is stored on the user node and not shared publicly. In some embodiments, the method comprises updating or creating a cryptographic state commitment for validating proofs of the updated state. In some embodiments, the cryptographic state commitment is associated pseudonymously or anonymously with the user and is recorded on a blockchain. In some embodiments, the method comprises constructing a Zero-Knowledge proof that attests to a validity of the updated state without revealing the state.

The present disclosure provides methods and systems for creating verifiable sustainability claims when the supporting evidence is confidential and scattered across numerous parties who may not be in direct communication with each other. The present disclosure provides systems and methods that utilize public blockchains and zero-knowledge proofs, facilitating collaboration on the validation of sustainability claims while ensuring confidentiality. The systems and methods provided herein may operate by making a public commitment to a consistent narrative and sharing claims related to the narrative, adjusted to the level of detail deemed suitable for the recipient.

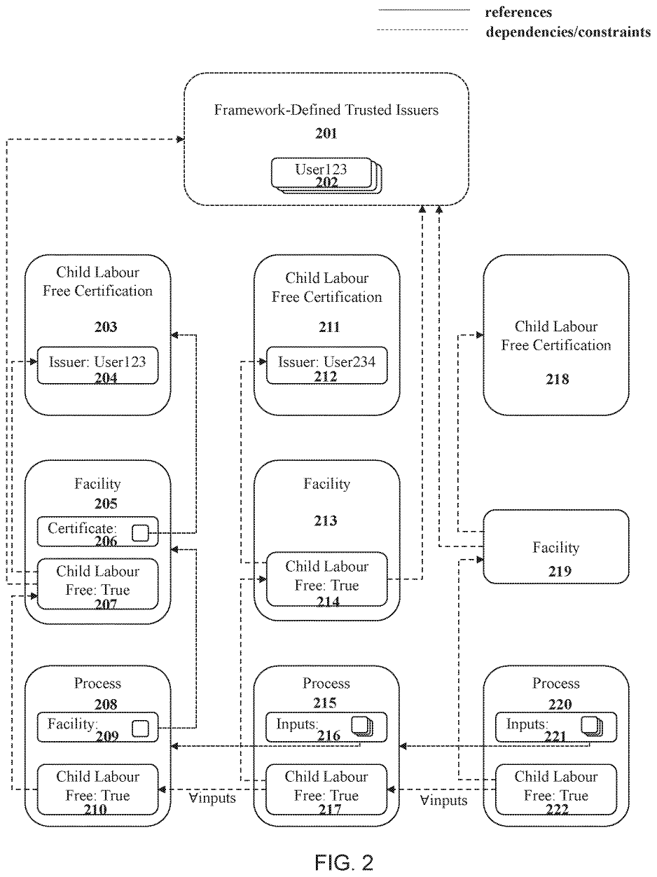

The systems and methods provided herein may comprise mechanisms that support flexibility in data entry, while ensuring that any alterations made to the narrative are made transparent to the parties receiving the claims. Unlike existing systems and methods, the disclosed systems and methods provide transparency and accountability in the representation of sustainability practices. For example, within a supply chain, the system may be capable of creating a knowledge graph that illustrates the flow and transformation of assets resulting from various actions, such as manufacturing processes and shipments (refer to the FIG. 2 for more detail). The system is capable of establishing a final product, for instance, a recycled shoe, as the reference subject. From there, it may start generating claims, such as the materials used to make the shoe, the sourcing locations of the individual inputs, or the proportion of the original feedstocks that qualify for a sustainability claim. Moreover, the system is capable of connecting this traceability data with existing traceability schemes, such as FSC, Fairtrade, and ISCC. This allows those claims to be substantiated using a predefined auditing standard and linked to a specific sustainability declaration, like a shipping manifest issued specifically for materials with sustainability characteristics. These declarations may be inherently included in the audit process. The approach may not be limited to material sourcing but may also be applicable to a broader range of sustainability factors, including carbon emissions, avoidance of slave labor, sourcing from conflict-free areas, and more.

FIG. 2 shows an example of the dependency graph of a collaborative inductive claim, specifically highlighting that a given end-product's supply chain is certified free of child-labor, in accordance with some embodiments. The illustration simplifies the Framework and omits similar Entries, constraint definitions, and history for brevity. Arrows, as defined in the key, indicate references and dependencies in the disclosed systems and methods. Each line pattern in the key represents a specific type of arrow, clearly distinguishing between references and dependencies. This allows for clear interpretation and understanding of the relationships and constraints within the system as depicted in the diagrams.

The diagram begins with Framework-Defined Trusted Issuers (201) representing entities that are trusted to issue certifications. User123 (202) is identified as one such issuer who grants a Child Labour Free Certification (203). The certification is linked to a Facility (205) via a certificate (206), affirming the facility is Child Labour Free (207).

This process is repeated with another trusted issuer, User234 (211), who also grants a Child Labour Free Certification. The certification is again linked to a different Facility (213) via a certificate (214), confirming that this facility is also free from child labor. A Process (208 and 215) is linked to each facility. This Process incorporates Inputs (216 and 221), which is the point where the produced goods from the child labor-free facilities enter. These inputs are affirmed to be Child Labour Free (217 and 222), based on the certifications granted to each facility.

FIG. 2 demonstrates how the system may create a knowledge graph that tracks and verifies the ethical credentials of materials within a supply chain, from their origin in a certified facility to their incorporation as inputs in a manufacturing process. This not only provides assurance about the sustainability claim but also allows for traceability throughout the supply chain.

Unlike traditional systems and methods, which merely layout information in a knowledge graph without comprehensive cryptography, the systems and methods provided herein enforce a transparent, consistent narrative while supporting derived claims, all without revealing the sensitive data used to substantiate these claims.

Contrary to traditional systems where users may have to give up data in full to a trusted authority who then attests to your claims, the systems and methods provided herein maintain confidentiality and integrity simultaneously. These do not just rely on the reputation of a single authority; instead, they rely on numerous, independent, crypto-economically incentivized parties for consensus on a single, updateable, global narrative. This is achieved by hiding cryptographic commitments to a public blockchain, and leveraging zk-SNARKs to maintain the internal consistency of that concealed narrative. This allows both comprehensive transparency and the maintenance of confidentiality, bridging the gap between full public disclosure and complete confidentiality.

While the systems and methods provided herein may allow users to validate their supply-chain operations, the systems and methods also may function as a transparent platform that actively invites and enables external entities to perform independent audits of the supply-chain operations, utilizing the robust verification capabilities of the systems and methods provided herein.

### 1. DEFINITIONS

### Consensus Protocols

Fault-tolerant consensus protocols refer to methods that enable computers, which may be controlled by different operators with varying interests, to reach an agreement under conditions that without requiring assumptions of entirely honest, faultless, and compliant behavior from all machines. For example, Bitcoin utilizes a consensus protocol to attain agreement on a ledger of transactions. Bitcoin operates based on the presumption that no single party controls more than a specified proportion of available computational resources. Similarly, Ethereum uses a consensus protocol to agree on transactions executed and smart contracts deployed, utilizing the amount of staked financial resources. The systems and methods provided herein apply these consensus protocols to achieve agreement on a consistent narrative of user actions and the resulting state in the system.

### Commitment Schemes

Commitment schemes are a method for a party to commit to a concealed value, creating a corresponding value known as the commitment, in such a way that it is infeasible (under some assumptions) for a party witnessing the commitment alone to learn the concealed value, a property known as hiding, and it is infeasible (under some assumptions) to convince a party that the concealed value corresponding to a commitment is anything other than the concealed value it is derived from, a property known as binding. Some commitment schemes have an even stronger property known as perfect hiding which ensures that given only the commitment, that nothing at all may be learned about the concealed value it corresponds to, without any assumptions about the computational resources available. A similar stronger property exists in the case of binding, but it is less relevant to this system and the two stronger properties may not be held simultaneously.

### Authenticated Data Structures

Authenticated data structures are a concept from delegated computation. Authenticated data structures allow an untrusted prover to carry out operations on a data structure while providing short witnesses to the correctness of those operations, and necessitating the storage of only a small commitment to that data structure, on the part of the verifier for keeping track of the state. These types of data structures are used in blockchain applications and zero-knowledge proofs and form the core of the system described herein.

An example of an authenticated data structure is the hash chain, or in the context of Bitcoin, the blockchain. The hash chain data structure is similar to a linked list, but with pointers replaced by collision-resistant hash functions. The data structure may be referred to by its root hash. Append operations may be verified by simply hashing the previous root with the appended data, or rather the hash of the appended data. Lookups of values deeper into the list may be done by providing the preimage of the hashes, which act as trustless pointers under the assumption of a collision-resistant hash function.

A more complex example of an authenticated data structure is the Merkle tree, which is analogous to a binary tree with pointers replaced by hashes. The Merkle tree allows for logarithmic sized lookups or updates of the binary tree by providing pre-images to hashes analogously to dereferencing pointers along the path. Some more specialized variants of the Merkle Tree that will feature in this paper are the Sparse Merkle Tree, Merkle Mountain Range, and Indexed Merkle Tree, which are useful for representing maps or sets with unbounded capacity, prunable append only logs with efficient lookups and low storage requirements, and maps or sets with bounded capacity, respectively. Details about the authenticated data structure are described later herein.

### Proofs of Computational Integrity

Proofs of Computational Integrity, particularly zk-SNARKs (Zero-Knowledge Succinct Non-Interactive Argument of Knowledge), are cryptographic techniques that have proven practically feasible for affirming that a certain computation was executed correctly on potentially private data, yielding a specific result. These proofs solely reveal the computation that was performed and the accuracy of its outcome, without disclosing the actual state or actions involved. Their compact size and swift verifiability are key advantages.

In the context of the system and methods disclosed herein, these proofs enable the execution of actions on some state over a period of time while maintaining agreement on the preceding and succeeding states. This ensures that the transition from the previous to the next state via the actions aligns with predefined rules without revealing the actual state or actions. The system allows multiple users to carry out these actions interactively and independently, fostering global consensus on their respective states and the sequence of actions. This behavior aligns with the desired operation of the system as outlined in the introduction.

### State and Commitments

The term “state” as utilized herein may refer to data that the business logic of an application depends on and manipulates via transactions. The validity of and result of those transactions may be conditional on the value of the state, and the result of those transactions becomes the new state. For example, in a banking application, the state may be the users' balances, and the transactions may be transfers between users.

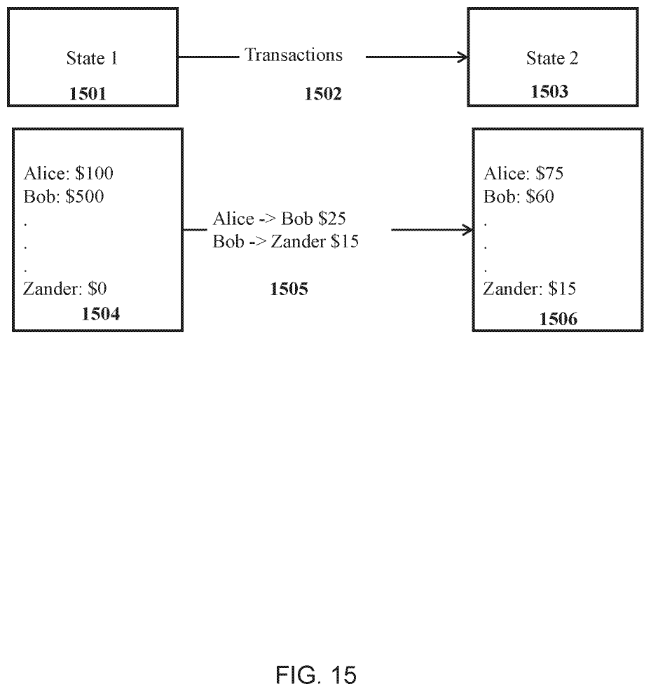

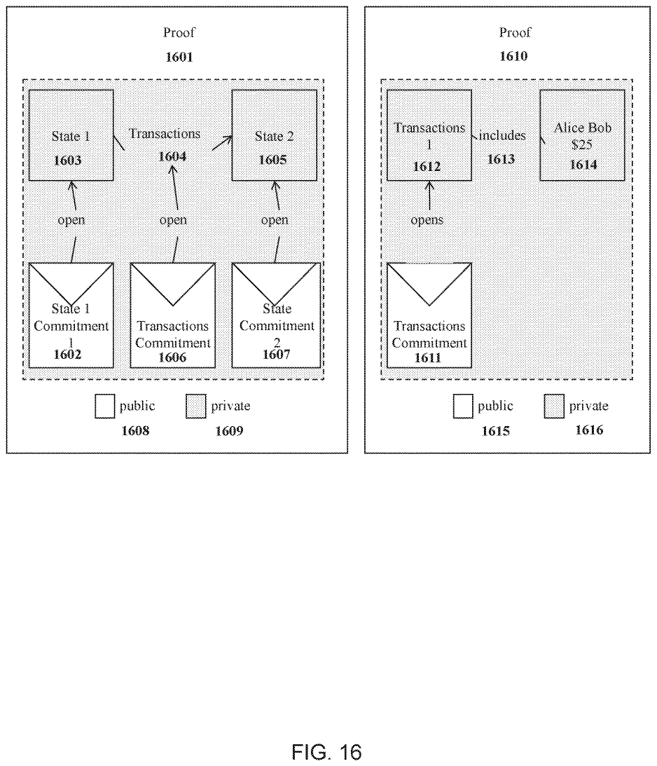

FIG. 15 shows an example of a simplified banking system illustrating the concept of state changes due to transactions within the system, in accordance with some embodiments. The initial state, State 1 (1501), shows Alice with $100, Bob with $500, and Zander with $0 (1504). The depicted Transactions (1502) include Alice transferring $25 to Bob and Bob transferring $15 to Zander. These transactions represent how state changes occur within the system based on user actions.

Transactions (1502) depict Alice transferring $25 to Bob and Bob transferring $15 to Zander (1505). These transactions result in a new state, State 2 (1503), where Alice now has $75, Bob has $60, and Zander has $15 (1506). This example illustrates how the “state” changes as transactions are performed within the system.

### State Commitment

The term “state commitment” or “cryptographic state commitment” utilized herein may refer to a cryptographic commitment to a specific state. This commitment is a piece of data that securely binds to the state without revealing it, similar to sealing the state in an envelope. Coupled with zero-knowledge proofs, the system may publicly commit to a state, transition the state commitment to a new one in accordance with predefined rules without disclosing the state or the updated state, and validate assertions about the state commitment to other parties, all while keeping the state confidential.

FIG. 16 shows an example of a proof (1601) that illustrates a state transition from State 1 (1603) to State 2 (1605) as a result of executing a specific transaction (1604), in accordance with some embodiments. This figure demonstrates how the system may provide verifiable proof of state changes due to specific transactions within the system.

The states and transactions are identified by their respective commitments (State 1 Commitment —1606, Transaction Commitment —1607, State 2 Commitment —1608) rather than the underlying data, ensuring the confidentiality of the data. The commitments 1606-1608 are made public, while the state transitions (1603 to 1605) remain private. FIG. 16 also illustrates a proof 1602 that confirms the inclusion of a specific transaction, “Alice sent Bob $25” (1611), within a set of transactions (1610). These transactions are identified by their transaction commitment (1609). The commitment (1609) is made public to verify the transaction, while the specifics of the transactions (1610-1611) remain private to preserve confidentiality.

The term “state root” generally refers to the top node of the Merkle-Tree structure used to make proving updates to the state efficient. A commitment to this root may be used as a commitment to the whole tree, and business logic may verifiably update one of the bottom nodes, which carry the actual data and are addressed by their position in the tree, and are referred to as leaves. This may be done using only information about the adjacent nodes along the path to the relevant leaf, and the root, which is logarithmic in the total number of leaves.

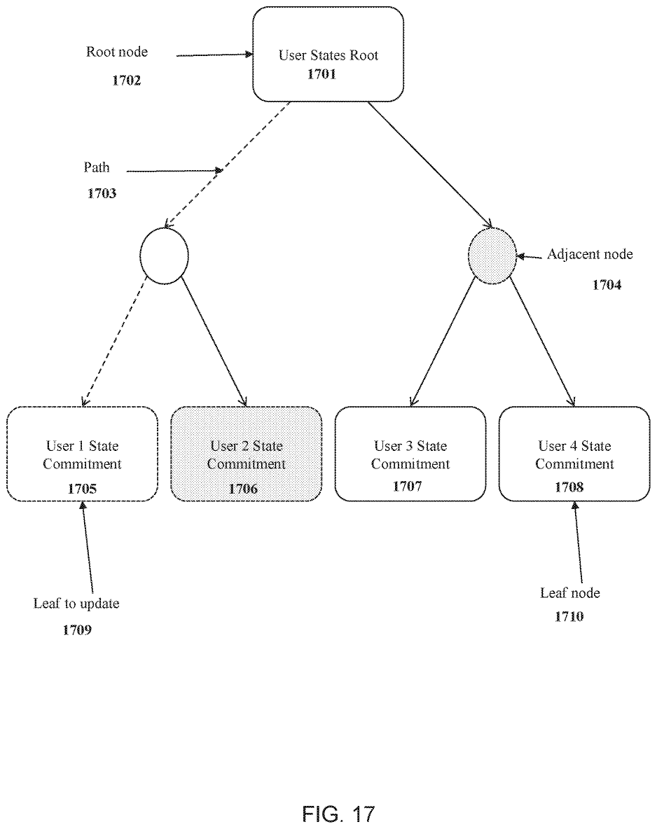

FIG. 17 shows an example of the User States Root (1701) within the system, providing a graphical representation of how user states are structured and managed, in accordance with some embodiments. This figure illustrates the User States Root contributing to maintaining and organizing user-related data within the system.

The Root node (1702) is depicted at the top of the structure, with various paths (1703) leading down to individual User State Commitments (1705, 1706, 1707, 1708). Adjacent nodes (1704) are shown along these paths. The figure also identifies a specific Leaf to update (1709), demonstrating how individual leaves (1710), or bottom nodes carrying the actual data, may be addressed for updates within this Merkle-Tree structure.

The term “state” in the system has two distinct connotations. Firstly, “State Proper” specifically refers to data read and modified by transactions to regulate subsequent claims. This includes data such as the remaining balance of an asset, which may prevent false assertions about resource consumption. This kind of state is not exchanged between users but serves as a regulatory mechanism to avoid contradictions. The term “general State” refers to all data in the system, including the existence and status of Entries, Disclosures, and Records. This encompasses claims that are recorded, which may form part of the “User State Commitment”. Despite being state, this data may be disclosed to other users. Due to the potential ambiguity, these definitions distinguish between the technical data constraints in the system and the data that records user activity.

The term “state-proper” refers to a specific structure of data within the system. This data consists of mutable key-value pairs, separate from claims and attributes, which may serve to impose constraints on subsequent transactions that generate claims. In some instances, these constraints are updated by the transactions themselves. This state data is not disclosed to other users, thereby maintaining confidentiality. The structure of the state-proper may vary depending on specific aspects of the system, such as when entries constitute the entirety of claims within the “State and Objects” framework, or when applying a UTXO-like state or an ephemeral state model under the “Scarcity and Spending” scenario.

The term “user state” generally refers to the cumulative state of all records for all frameworks, along with any framework-specific state that is not tied to a specific record. This includes all data that may be involved in transaction logic or disclosures. In some cases, user state may refer to all the states related to a user node or a user account.

The term “global state” may refer to the framework-specific state not linked to a particular record. It may not refer to the state of all users. This term is used to underscore the fact that this state is not “local” to any individual record but applies across various records under a specific framework.

In addition to the user state and the framework-specific state, the term “global state” is used in two other distinct ways. First, it refers to the overall state of the system, including the states of all users and any shared state among users such as a shared log or bulletin board. This global state is recorded on the blockchain, making it a subject of consensus among the participants in the network. Second, the term “global state” is used to describe the state of a specific framework under a given user. This framework-specific state forms part of the comprehensive global state of the system, serving to regulate transactions and claims within that particular framework.

In its first usage, “global state” signifies the collective state of the system, including all user states and any shared state. This definition is particularly relevant in the context of proof generation within the system. The systems and methods disclosed herein may utilize a public input during proof creation, to specify what the proof is verifying. However, using a user's state commitment as a public input may reveal too much information. To maintain confidentiality, the global state, which includes all user states, is used as the public input instead, effectively concealing individual users within the updated collective state. For instance, when a user wishes to associate an asset with a shipment recorded by another user, using the other user's state commitment as a subject may inadvertently reveal an excessive dependence on that user in the supply-chain. By referring to the global state instead of an individual user's state, the system maintains confidentiality while verifying proofs.

In the systems and methods disclosed herein, several key terms are used to describe various aspects of the system and its functionality. These terms and their simplified, illustrative examples are outlined in Table 1 below:

2.

TABLE 1
Key Terms and Examples

| Term | Concrete Example |
|---|---|
| Claim | 0.5T of the batch of Recycled Plastic #123 I received in Shipment #345 was |
| | used in this process |
| Record State | Shipment #123 |
| | State: |
| | Remaining balances: |
| | Recycled Plastic #123: 10T |
| Record State (in | Claims: |
| the general sense) | “0.5T of the batch of “Recycled Plastic #123” I received in Shipment #345 |
| | was used in this process”: valid |
| | “0.8T of the batch of “Recycled Plastic #123” I received in Shipment #345 |
| | was used in this process”: invalidated |
| | “There was 0.4T of output”: valid |
| | State: |
| | Remaining balances: |
| | Process output: 0.3T |
| User State | Framework - ACME Recycling Credit Trace Certification |
| | State: |
| | Outgoing Shipments for Bookkeeping Period: [Shipment 567, Shipment 678, |
| | Shipment 789] |
| User State (in the | Every claim/record/framework tracked for that user in the system and its |
| general sense) | status and history |
| User State | A fingerprint of a snapshot of the whole User State (in the general sense) that |
| commitment | does not reveal the actual contents of it, while nonetheless binding the user to it. |
| Global State | Every user's state (commitment) and any shared state such as a bulletin |
| | board, or tracker of nullified (privately updated) disclosures, or tracker of |
| | nullified (privately updated) user states |

In the high-level system description, the term “frameworks” may refer to aspects of rule enforcement and the capacity to constrain data and formalize claims within the system.

“Records” are designed to dynamically reflect changes over time. “Entries” are foundational claims and discusses their evolution in accordance with framework rules. Entries encompass the totality of claims.

“Disclosures” are a type of claims that are managed as Disclosures. In the context of system description, “Disclosures are selections shared with other users, subject to mechanism of invalidation and consistency enforcement through state mechanisms. The interact between disclosures and entries include logical dependencies on attributes of local and non-local subjects/records and dependency constraints for non-local subjects/records. Entries are defined as the most constraining claims, which are the basis facts or most constraining statements. Disclosures are highlighted as predicates on specific attributes of the record and as encompassing multiple Entries.

“Transactions” may be operations in the system. Transactions in the system may need to comply with the rules defined in the Frameworks. Validation mechanisms are involved in the transaction process. Transactions are constrained by Entries and Disclosures. Transactions may be unconstrained and rule compliance is verified indirectly.

Entries and Disclosures can be constrained by Framework Business Logic Expression. For example, the business logic expression defines forward propagation of predicates via attribute definitions Directed Acyclic Graphs (DAG), and the propagation of attribute constraints through the dependency DAG.

The system features various “Approaches to Guaranteeing Recency of Data” that are mechanisms for ensuring the currentness and relevance in data handling. For example, “staleness” is employed in data management and forced propagation and revocation methods employed to ensure data validity.

The term “incremental claims” may refer to users to add or update claims over time, facilitated by the dynamic nature of Records allowing for flexible claim updates.

The term “derivation of Claims” may refer to records capturing and managing evolving knowledge, facilitating claim derivation, ensuring that logical dependencies, ensuring derived claims remain in sync with the foundational data and previous claims.

For the construction of “Relative Claims”, Disclosures are used to depict relationships between claims, thereby maintaining context and referencing, as elaborated in HL-DD. DD-DIS2.1 and DD-DIS2.2 further discuss that Disclosures include predicates that address related claims, ensuring consistency across interconnected claims.

In terms of “Public verifiability of system integrity”, systems and methods utilize zk-SNARKs to ensure each state transition adheres to the predefined rules. With interaction with the public blockchain, viewers may verify system integrity transparently, and Merkle Trees provide an authenticated data structure for efficient system state verification.

Systems and methods herein may allow for “concealment of transaction details from public view” by utilizing transactions designed to function without revealing underlying data publicly, a process achieved through zk-SNARKs. Furthermore, Disclosures are used to allow the sharing of selected information without revealing the entire dataset.

Systems and methods herein may allow for “concealment of transaction details from system operators” by having operators process zk-SNARK proofs without accessing the underlying data and Disclosures further allow for selective data sharing without needing to provide details to system operators.

Systems and methods herein may allow for “concealment of witness data” by using Disclosures to handle claims by revealing predicates about the witness data, not the witness data itself, enabling secure and confidential data sharing.

Problems with Existing Methods and Systems for Producing Verifiable Sustainability Claims

Existing systems for producing verifiable sustainability claims typically rely on either full transparency, or appeal to privileged authorities to provide evidence for the legitimacy of said claims. Alternatively they attempt a weaker, more traditional notion of verifiability, in which, rather than auditing the basis of the claims, the user is given a non-repudiable, signed version of the claims, guaranteeing its authenticity. As an example, Verifiable Credentials (VC) is a specification developed by the World Wide Web Consortium (W3C) that may digitalize existing trust infrastructures. It allows entities to receive or issue non-repudiable and revocable credentials from trusted issuers, identified by their Decentralized Identifier (DID). These credentials may be presented in a Verifiable Presentation, a process by which entities may without permission prove that they are the holders of the credentials and selectively disclose credential fields. The recipient of the presentation may then verify that the credentials were indeed issued by the claimed issuer. Various efforts are underway to adopt this technology for authentic data exchange in supply chains, either through credentials issued by the entities themselves or by trusted third parties.

Verifiable Credentials (VC) may only offer a mechanism for ensuring the authenticity of claims. The issuer of the VC, by attesting to the claims, may stake their reputation on the veracity of these claims. However, the extent of this stake may be contingent on the risk of being exposed may the claims be found to be false. To reduce liability and enhance the credibility of claims, users may opt to include the foundational VCs along with their original issuer. This alternative may allow the users themselves to attest to the claims based on the presented VCs. However, doing so may inadvertently disclose extensive details about the structure of their supply chains and the involved actors, assuming they are even allowed access to those source VCs. This approach may provide an assurance of authenticity, but may not inherently guarantee the integrity of the claims.

The property of authenticity alone is also not sufficient to guarantee a consistent narrative. An entity may provide different information to different parties and without a relay to a central trusted party, variations in the narratives may not become apparent. Potential collusion between parties may lead to the creation of manipulated information, further complicating the narrative. This becomes particularly noticeable in contexts that involve respecting scarcity, such as avoiding double spending or overspending of assets, or complying with a facility's theoretical manufacturing capacity. Thus, while authenticity of credentials may be a factor, mechanisms to help ensure the consistency of narratives are also a part of these systems.

Another existing method is confirming compliance via transparency on public blockchains. If supply chain actions and chain of custody are published openly on a public blockchain, an authentic and publicly binding audit trail may be established. It enables self-verification of the consistency of claims by algorithmically examining them. Alternatively, a light client may be used, which checks if independent validators have vouched for the adherence to the rules, often at significant financial risk to themselves. This approach offers robust trust guarantees and accountability. However, it may not maintain secrecy of data. There may be supply chain actors who are unable or unwilling to provide all related data publicly and transparently.

A further existing approach involves concealing transaction fields that are not involved in the business logic through the use of cryptographic commitments, while pseudonymously identifying subjects and actors. Statements regarding supply chains may be substantiated leveraging the committed confidential information. This information need not be provided publicly or to a central trusted authority. Instead, it may be verified using off-chain zero-knowledge proofs that are exchanged peer-to-peer. This approach balances between transparency and data privacy. However, it is worth noting that data from the transparent transaction fields and pseudonymous supply chain graph may carry sensitive information. Public data may provide insights into pseudonymized recipe ratios, centralization risks in supply chains, and potential opportunities to bypass intermediaries, among other details. Additionally, correlations may be made with auxiliary real-world information. One may draw parallels to other contexts, such as the use of pseudonymous transaction data in cryptocurrencies, which has sometimes been used for deanonymizing users through analysis methods.

Lastly, the existing methods may involve trusted authorities and private blockchains. These entities may be able to attest to the consistency of the overall narrative and act as witnesses to the underlying data. This approach may be employed for the global narrative, comparable to the public, transparent case described earlier, but with the underlying data exposed only to these privileged parties. It implies the need for a group of entities entrusted with securing the highly sensitive data, processing it honestly, and agreeing upon a consistent ledger of actions within the system. There may be the possibility of utilizing technologies such as threshold homomorphic encryption. With this approach, parties operating the system may work on data encrypted under a global public key and may be unable to decrypt this data without collusion. This may potentially mitigate the risk of data compromise, but current performance levels may make this approach impractical due to overheads and the necessity for the committee of trusted parties to store the encrypted data. As these schemes rely on computational hardness assumptions, an invalidation of these assumptions may mean that compromising only a single committee member may lead to revealing all the stored private data. A further issue exists about who can comprise the committee remains, and is politically fraught, and runs into the issue that those who may be trusted to operate the system are not necessarily those who have the appropriate technical expertise, and vice versa.

### Improved Systems and Methods

The systems and methods described herein may improve over the existing methods and systems and address the above needs. The systems and methods described in this disclosure present an approach where users process, verify, and maintain control over their own data. Users commit to this data and their actions on a consensus layer that is credibly neutral, providing robust guarantees of persistence. The validity of the processing is demonstrated privately using zk-SNARKs. By utilizing zk-SNARKs and commitment schemes with perfect hiding, the computational hardness assumptions are shifted from the confidentiality of the data, which becomes unconditional, to the ability to cheat, by either creating fraudulent proofs or fraudulent claims about the data underlying commitments. This positions the systems and methods disclosed herein as an innovative solution for secure data management in scenarios such as supply chain transparency.

The systems and methods disclosed herein are designed such that creating convincing fraudulent claims of compliance becomes computationally infeasible, based on the assumptions about available resources and the resources required to solve certain computational problems. Additionally, extracting more information about the committed data beyond what has been disclosed is highly improbable. One consideration in these systems and methods is the determination of appropriate levels of disclosure for the recipient. Multiple disclosures may lead to inferences, influencing how these claims are formalized and substantiated. Hence, these systems and methods aim to balance data confidentiality with the need for transparency and verifiability.

The systems and methods disclosed herein unite multiple capabilities for robust data management. The systems and methods disclosed herein utilize third-party issued credentials to support the validity of certain claims and demonstrate the ability to carry out specific actions. At the same time, these systems and methods provide strong confidentiality and anonymity guarantees, ensuring a consistent narrative across all transactions and interactions within the system.

The systems and methods disclosed herein offer a flexible approach towards the registration and communication of data. They allow for variation in the order of data registration, the level of detail in the registered data, and the completeness of the data communicated. They also accommodate the correction of errors and omissions. All this is achieved without compromising the integrity and clarity of the claims or revealing the underlying sources of those claims. They prevent corrections from being used to create conflicting claims that are not transparently suspicious to the recipients. These systems and methods also include the preservation of scarcity without compromising confidentiality, thereby preventing users from implicitly exhausting the same resource multiple times through the use of secrecy.

While there are related systems, such as ZCash, Aztec, and Aleo, that combine blockchains and zero-knowledge proofs for special-purpose private cryptocurrency transactions or general-purpose privacy-preserving smart contracts, these systems often leverage encryption rather than commitment schemes. Given the public nature of these systems, this approach may potentially run the risk of store-then-decrypt scenarios may the encryption scheme be compromised. However, the systems and methods disclosed herein make use of commitment schemes to secure data, addressing these potential vulnerabilities.

For highly sensitive data, the guarantees provided by encryption-based systems may not be adequate. Furthermore, the presence of such tools and platforms does not necessarily inform on how they may be leveraged to implement privacy-preserving traceability systems. These systems may need to be flexible enough to accommodate real-world use cases, requiring features like updates, revocations, and incremental data entry. The systems and methods disclosed herein aim to address these considerations, providing a framework for what such a system may look like.

In the context of the systems and methods disclosed herein, “verifiable” refers to the provision of cryptographic evidence that may be challenging to construct unless the claim is made in a manner consistent with formally defined rules and its existence is agreed upon by the consensus mechanism.

“Confidential” in the context of the systems and methods disclosed herein pertains to the optimal minimization of information disclosed beyond the core claim. This extends to not only the subject matter of the claim, but also encapsulates pertinent aspects of the claim's derivation. These aspects may assist in fostering an environment of trust around the claim. However, it is not explicitly stated that these elements are requisite or may be helpful for the overall functioning of the system. The disclosed systems and methods offer a flexible framework that permits various levels of confidentiality based on specific requirements and contexts.

“Consistent” in the context of the disclosed systems and methods refers to the adherence to predefined rules or conditions, ensuring that all entries and claims within the system maintain uniformity and do not contradict each other.

“Collaborative” indicates that within these systems and methods, Entries may be verifiably derived from other Records created by different stakeholders. These Records themselves may also be derived from other Records, reinforcing the collaborative essence of the system.

A “Claim” is defined as a bounded statement about a subject. It may be asserted directly or deduced from other existing claims within the system.

A “Record”, in the context of these systems and methods, represents an assembled collection of claims that pertain to a specific subject.

An “Entry” is a specific claim associated with a Record within the system.

### Record and Entry Versioning

“Record and Entry Versioning” pertains to the management and updating of Entries or distinct assertions about a subject over time in the systems and methods disclosed herein. This includes multiple methods for tracking the evolution and amendments of Entries.

“RV1” refers to an incremental and sparse method for setting Entries, featuring an append-only log that documents the progression of each Entry. Entries are versioned, with each version encapsulating the most constraining or stringent claims.

“RV2” describes a method where Entries are set instantaneously within a single instance known as a version. It allows for state modifications resulting from the creation of Entries in other records without necessitating the creation of a new version. The integrity of the subject record is thus preserved, and a log of versions maintains historical tracking.

“RV3” depicts a hybrid approach where records are versioned and designated instantaneously. However, versions are comprised of references to Entries, potentially created in previous versions, preserving the same identity and linked metadata of the Entries across versions.

Collectively, these options demonstrate the adaptability of the disclosed systems and methods for managing and tracking the evolution of Entries within Records, ensuring accuracy and consistency in the face of updates or modifications.

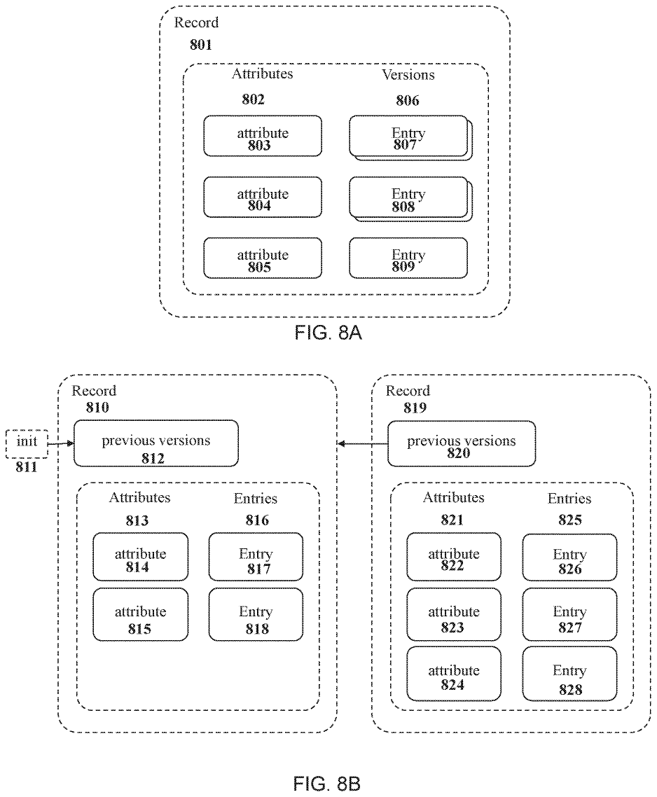

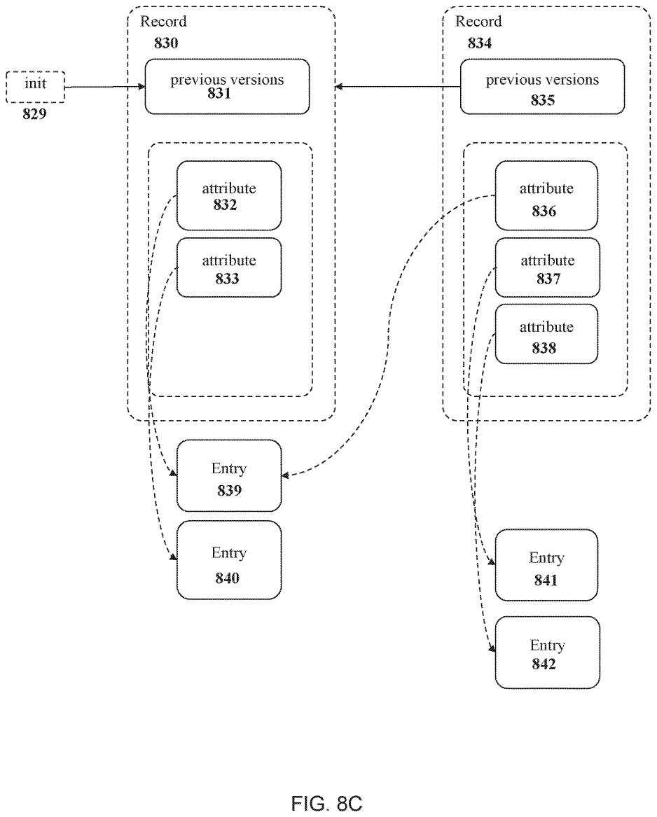

FIG. 8 illustrates different methods for versioning of Entries and Records in the system, in accordance with some embodiments. Specifically, FIG. 8A shows an example of Records as collections of versioned Entries, FIG. 8B presents Records as versioned collections of Entries, and FIG. 8C depicts Records as version collections of references to Entries. Each figure represents a unique approach to managing and tracking the evolution of Entries within Records, demonstrating the versatility of the disclosed system in handling versioning.

FIG. 8A shows an example of a Record (801) within the system. The Record is comprised of various Attributes (802), specifically attribute 803, attribute 804, and attribute 805. Each attribute in the system has multiple Versions (806), represented by distinct Entries (807, 808, 809). This diagram exemplifies one way of organizing and managing Entries within a Record in the system, in accordance with some embodiments.

FIG. 8B shows an example of a versioned Record (810) in the system, showing its initial state (811) and its previous versions (812). The Record contains several Attributes (813) including attribute 814 and attribute 815. Each attribute corresponds to an individual Entry (817, 818) under Entries (816). Following this, another version of the Record (819) is shown with previous versions (820), multiple Attributes (821, 822, 823, 824), and corresponding Entries (825, 826, 827, 828). This figure demonstrates another way of managing Entries within a Record in the system, in accordance with some embodiments. FIG. 8C shows an example of a hybrid approach to record and entry versioning within the system. It starts with an initial state (829) and proceeds to a Record (830) with its previous versions (831) and attributes (832, 833). Following this, another version of the Record (834) is shown with its previous versions (835), multiple attributes (836, 837, 838), and corresponding Entries (839, 840). Additional Entries (841, 842) are also depicted which maintain the same identity across different versions. This figure represents a unique approach to managing and tracking the evolution of Entries within Records, demonstrating the versatility of the disclosed system in handling versioning, in accordance with some embodiments.

While the overarching objectives of the system have been referenced in broader terms in previous sections, this section enumerates specific properties and functionalities. These are some of the notable features of the systems and methods described herein.

In some embodiments, the systems and methods described herein may establish a public consensus on the system state. In some embodiments, the systems and methods described herein may promote an unambiguous and consistent understanding among all participants about the transactions that have transpired, and if relevant, their order. Such a configuration makes it highly improbable, after a specific point in time, to dispute a particular sequence of transactions within the ledger.

In some embodiments, the systems and methods described herein may be configured to support public verifiability of system integrity. Such a feature may allow for efficient verification that the evolution of the system up to a certain point has followed the designated rules, culminating in a specific state or state commitment.

In some embodiments, the systems and methods described herein may offer a feature that allows users to conduct transactions and update the state of their account without publicly revealing the underlying details of their transactions or state, thereby preserving the confidentiality of user transactions within the system.

In some embodiments, the systems and methods described herein may include a feature that enables users to transact and update their account state without disclosing the underlying details of their transactions or state to the system operators. This means system operators, who process the transactions and state updates of users, do not require privileged access to the underlying data, thus enhancing user privacy.

In some embodiments, the systems and methods described herein may comprise a feature that enables users to disclose claims made within the system to other parties, without revealing the underlying details of the data substantiating the claim. This means the existence and veracity of the claim, with respect to the system logic, may be confirmed while preserving the confidentiality of the witness data.

In some embodiments, the systems and methods described herein may be configured to allow for incremental claims. This means that a user does not have to make all claims about a given subject at the same time. It is possible to provide additional information at a later time, for instance, if the information was not previously available. This feature adds flexibility and allows for the integration of new information as it becomes available.

In some embodiments, the systems and methods described herein may be designed to allow for the derivation of claims. This feature enables the use of claims made by other users, or the users themselves, as evidence to substantiate other claims. According to the agreed rules, these derived claims either follow from or are contingent upon this evidence, providing a robust mechanism for evidential claim substantiation within the system.

In some embodiments, the systems and methods described herein may be configured to allow for updatable claims. This feature enables users to update or override claims about a subject, providing additional detail that was not present in the original claim, or even directly contradicting it in light of new information. This flexibility allows for the system to adapt and accommodate evolving information over time.

In some embodiments, the systems and methods described herein may include a feature that promotes transparency of inconsistency or invalidation. This means if a user makes contradictory claims, such as overriding specific attributes of a subject, or contradicting a precondition of a derived or contingent claim made earlier, it may be highly unlikely for the user to credibly assert that the contradicted claim remains valid from that point onwards unless it may be demonstrated otherwise. As a result, contradicted claims may be considered suspect and effectively bound to an expiry. This feature enhances the transparency and reliability of information within the system.

In some embodiments, the systems and methods described herein may be configured to allow for efficient communication of inconsistency. This feature enables the updating of users on the status of claims with the complexity being dependent on the number of updates rather than the total number of claims disclosed to that user. This approach allows for an effective communication of changes or inconsistencies without overwhelming the user with unnecessary information.

In some embodiments, the systems and methods described herein may be designed to support the creation of relative claims. This means if a subject holds a directed relationship with another subject, such that the other subject is the value of an attribute of the original subject and a claim exists about that other subject, it may be possible to derive a claim about that other subject in the context of its relationship with the original subject. This feature enables a more nuanced understanding of the relationships and dependencies between different subjects within the system.

In some embodiments, the systems and methods described herein may be designed to support the authenticity of claims. This feature allows for the provision of the source of a claim, or supporting evidence, to some level of detail or in relative terms, with respect to the identities within the system. It is configured such that it may be highly unlikely to produce such a claim fraudulently, and the provided evidence is non-repudiable. This feature enhances the credibility and trustworthiness of claims within the system.

In some embodiments, the systems and methods described herein may be designed to allow for the propagation of inconsistencies or invalidations. This feature means that if a claim is dependent on another claim that has been invalidated, it may no longer be feasible from that point onward to assert the validity of the dependent claim. Consequently, the dependent claim becomes bound to expiry. This feature enhances the system's ability to maintain integrity and consistency of claims.

In some embodiments, the systems and methods described herein may be designed to enforce scarcity respecting claims. This feature allows for the enforcement of certain claims to respect a concept of scarcity, whether it is a recoverable resource like warehouse capacity and unit occupation, a non-recoverable resource such as material converted by an irreversible process, or a singular assignment such as the receipt of a shipment. This feature promotes the accurate representation and management of scarce resources within the system.

In some embodiments, the systems and methods described herein may allow for various levels of granularity in making claims. This feature enables users to make claims with varying degrees of precision or ambiguity, representing their own state of knowledge, which may not always be a precise value. This flexibility allows for a more accurate representation of users' knowledge and uncertainty within the system.

In some embodiments, the systems and methods described herein may support varying levels of disclosure. This feature allows users to derive less specific claims from more precise ones for the purpose of selectively disclosing these at a level of detail that is appropriate for the audience. It includes predicates over the metadata of the claim. This flexibility enhances the adaptability of the system for different audiences and use cases.

In some embodiments, the systems and methods described herein may allow for derivation from disclosure. This feature enables a user to substantiate and derive their own claims from less specific claims that have been derived and then disclosed by other users, according to predefined rules. This functionality enhances the system's ability to integrate and build upon shared information.

In certain embodiments, the systems and methods described herein may support interoperability of claims between rule systems. This feature enables a user to leverage claims made within one system of rules, representing some regulatory system or certifying scheme, to derive claims in another system of rules, provided that the specific system of rules permits such usage. This functionality enhances the system's adaptability and compatibility with different regulatory systems and certifying schemes.

### System Description

Present disclosure provides systems and methods, leveraging blockchain and zero-knowledge proofs, for producing claims that are resistant to silent post-hoc manipulation and inconsistency associated with data entry and/or validation of subsequent derived claims, with applications to supply chain transparency. Upon this foundation, a full-scale traceability and compliance solution may be implemented that conducts the whole process from data needs definition, and data gathering, to verification and auditing, without reliance on human trust, or the revelation of private data, for assuring the integrity of those processes according to defined rules, and without reliance on a single trusted authority for the consistent reporting of what was recorded.

Following includes components of the method and system herein:

Public Commitment Stakeholder(s) interacting with the system publicly contribute commitments (or aggregates thereof) to Records and Entries. These Records reference either a single or a collection of consistent claims (Entries) about a certain object, entity, processing step, event or characteristic, which may in turn also be an aggregate of other linked claims.

Consensus The totality of committed Records and Entries are agreed upon by a fault-tolerant consensus mechanism, for example a public blockchain.

Linkage of Dependencies Committed with the Entries are references to any other Entries whose veracity they immediately depend on and whose veracity immediately depends on them.

Linkage of Updates Entries referenced by Records may also be updated but the process by which this update occurred and the previous Entries being overwritten are specified.

Public Verifiability The integrity of the process by which the committed Records and their Entries were created, the existence of their dependencies, is verifiable by all stakeholders within the system, without revealing the details of the process or the identity of the dependencies via a zero-knowledge proof.

Logic Transparency Entries may be made which (verifiably) reference the details of the process by which other Entries were created (e.g. self-issued claim, verifiably inferred from specified rules, audited/permitted by a third party)

The systems and methods disclosed herein encompass a Verifiable Disclosure method for sharing Entries from Records between stakeholders. This method leverages the inherent properties of the system to ensure: a) the disclosure of Entries alongside a verifiable audit trail at an appropriate level of detail, preserving their veracity while maintaining confidentiality; b) a consistent narrative for a given Record, with any deviation made evident, prohibited, or rendered suspicious by omission of evidence; c) the verifiability of claims respecting scarcity or double-spend prevention, such as transfers of finite assets or restrictions on asset volumes; d) the maintenance of stakeholder and subject identity protection through relative claim nature, ensuring authenticity while widening the disclosure scope; and e) the veracity of disclosee's Entries based on the veracity of the disclosed Entries, given their verifiable correspondence with committed Entries.

The decentralized system may allow stakeholders to produce verifiable Digital Product Passports, which provide a publicly verifiable trail ensuring consistency, authenticity, and integrity for claims about subjects, identified by their relation to a reference subject, while ensuring privacy beyond the veracity of the claims.

Notably, it achieves this without depending on a single central authority or auditors for trust in the consistency of narratives, balance checks, evident changes, and predicate holds, while also avoiding unnecessary disclosure of private information for the same end. This frees up auditors to approve the capabilities of stakeholders (e.g., certifications, warehouse capacity) and bridge the gap between records and reality.

In the system, every user has a private state recorded on their user node. This state includes the complete set of records and claims (entries, disclosures) made, any additional metadata about them, auxiliary data needed for creating proofs, additional elements needed to enforce the rules of the framework, and other yet unspecified data. This state is then committed to by one singular cryptographic commitment to an authenticated data structure, or alternatively, multiple cryptographic commitments and nullifiers. These commitments are then published to a public blockchain. The publication of these state commitments results in an update to the globally agreed-upon state, which consists of these state commitments and potentially additional data. The publication of the state-update is contingent upon the verification of a zero-knowledge succinct non-interactive argument of knowledge (zk-SNARK) that the state update was a result of a valid state transition. The state commitments contain encoded metadata about the specific methods used or claims made as allowed by the framework, which informs the user verifiably about what is being claimed. This is all enforced by the global business logic.

### Frameworks

The systems and methods may comprise Frameworks. Frameworks may represent various regulations and certification schemes that users may desire to comply with or at least provide evidence of compliance. Frameworks guide data entry towards consistent schemas and formalize claims within the system, ensuring uniformity and compliance with the desired standards or regulations.

In many instances, the same data about the same subject may be expressed in multiple ways, and the rules in regulatory systems may be interpreted and formally expressed differently. The systems and methods disclosed herein address these issues by specifying Frameworks. These Frameworks consist of a set of rules dictating how data is entered and claims are substantiated. This constrains the number of ways a user may try to satisfy a claim, meaning these rules alone need to be evaluated by qualified parties to determine if claims within the system match the criteria of the relevant regulatory or certification scheme. This approach reduces the expectation for users to understand the precise formalization of the satisfied statement, enhancing the overall usability and efficiency of the system.

In some instances, defining how these claims may be checked using existing zero-knowledge proof systems becomes particularly helpful. These systems may require specific tailoring to accommodate the unique features of the underlying proof system for optimal performance. This is another aspect the systems and methods disclosed herein consider for enhanced efficiency and accuracy.

The systems and methods disclosed herein may constrain the formal expression of claims via Frameworks. This approach, while potentially reducing the total work involved in auditing the correspondence of claims to real-world meaning, also allows for the collaborative construction of inductive claims across supply chains. This is facilitated by the consistency in the semantics of the claims among various parties, including those whose claims may not be directly audited by the final verifier.

The systems and methods disclosed herein shift the traditional auditing process. Instead of auditors, track and trace providers, accounting services, and other providers being certified based on their ability to comply with specific rulebooks by appropriate authorities, the intent is for the Framework itself to be certified. This implies that as long as it may be proven that the Framework was used and the evidence provided under the Framework's definition met appropriate standards and was compliant, the specific operator or service provider becomes less relevant. Given the highly specialized nature of specifying constraint systems for zk-SNARKs, either the Framework may need to be audited by specialists trusted by the appropriate authorities, or a Domain-Specific Language auditable by less specialized authorities may be needed, with its translation into provable constraints audited by specialists. As a result, trust is not eliminated but is made legible and subject to public scrutiny, shifting from providers to the implementation of the Framework itself.

Frameworks being flexible, transparent formalizations of standards of evidence, may also define how they interoperate with other systems, and manners of providing evidence. Such as whether a Verifiable Credential issued by a certain authority is a sufficient standard of evidence, or the set of entities suitable to notarize externally sourced information, or which bridges or notaries of the state of other Verifiable Data Registries are considered trusted.

### Records and Entries

In the context of the systems and methods disclosed herein, Records are the objects described by Frameworks. A Record, in its entirety, represents a user's knowledge or attestations about Framework-specified attributes of a given subject over time. These Records are dynamic, reflecting a user's growing understanding of the Record's subject over time, accommodating potential corrections of errors in entry or measurement, revocation of credentials, or pre-emptive claims that certain details were conditional on, among other stateful attributes such as whether or where an asset was spent. However, this evolving knowledge or attestations about the subject are distinct from changes in the state of the subject itself, or its current state, which are depicted differently. The aim of these systems and methods is not to represent the current state of the subjects as such, but rather the narrative of how they reached their current state, and the evolution of users' knowledge and claims about this progression.

In some embodiments, in the systems and methods described herein, each subject may have at most one record per user per framework, although there are no other constraints. Over time, evolving claims about aspects of the subject or the result of transformations of the subject may be represented by multiple records. However, each subject may be identified by a specific Root Record, providing a distinct identifier for each subject within the system.

In the systems and methods described herein, Entries represent the foundational claims made by users about the attributes of subjects described by records. These Entries reflect the users' current state of knowledge and judgment. They present the most precise and restrictive understanding of a subject's attributes that a user has available within the system, serving as the primary source for deriving further claims. This feature enables the system to accurately represent and utilize the users' knowledge and understanding of the subjects.

In the systems and methods described herein, every attribute of a record has an associated entry designated by a user. This entry encapsulates the user's latest and most constrained claim about that attribute. These entries constitute the record's state, which evolves as entries are updated or revised based on new information shared by counterparties, corrections, or derivations. This feature serves as a mechanism for maintaining consistency of claims about the same subject within the system.

In some embodiments, the systems and methods described herein preserve the history of each entry for an attribute. This includes documenting how and when claims were made, and the information on which they were based. This historical preservation provides a comprehensive and chronological record of claims, enhancing the system's transparency and traceability.

### Disclosures

In the systems and methods described herein, a Disclosure is a type of claim that serves as a predicate over an entry's history, the record's history, and its associated metadata. Disclosures are shared with other users, forming the basis for their own claims. While Disclosures, as predicates over a claim, do not alter the state of a record, they may serve as a version of the input claim at a level of detail sufficient for the recipient's understanding and the derivation of their own entries and Disclosures.

In the systems and methods described herein, Entries not only make a statement about an attribute but also specify (or imply, based on the framework constraints) how they were created. Consequently, Disclosures act as predicates over both the attribute and the process by which the Entry was created. This distinction may help to differentiate, for instance, claims asserted by a user about an event or subject upstream in the supply chain versus a claim derived from first-party data about the event shortly after its occurrence. It also distinguishes claims supported by a valid credential from a reputable authority, without revealing the credential that supports it. This feature enhances the specificity and comprehensiveness of Disclosures within the system.

### Global Execution Environment

The Global Execution Environment leverages public blockchains to ensure a single state commitment agreed upon by all participants, maintaining an immutable and consensus-driven state. In some embodiments, methods and systems herein may employ zk-SNARKs and other zero-knowledge proofs, along with Merkle Trees and Cryptographic Accumulators, to provide a mechanism for globally verifiable state updates, ensuring transactions without revealing underlying data, and consistent system state updates.

The global execution environment, as described in the systems and methods herein, allows for efficiently proving within a transaction that certain claims, both internal (created by the user issuing the transaction) and external (created by another user and communicated to the user issuing the transaction), exist and were deemed valid as of a specific timestamp. The system is structured in a way that enables global validation without specifying which particular user created the claims referenced by the transaction. In some cases, a state is organized into a global root commitment. This commitment encapsulates, but, in some instances, does not reveal, all claims made by users up until a given timestamp. This forms a large anonymity set over both claims and the users issuing them, while still allowing public confirmation that the claims used actually exist in the system and satisfy what is required of them. The root commitment may be used as a public input to the proof confirming the user's state transition and created claims, which may be publicly verified. Meanwhile, the private witnesses of that proof are used to confirm which claims were used, their existence, and their properties, without revealing them to the verifier.

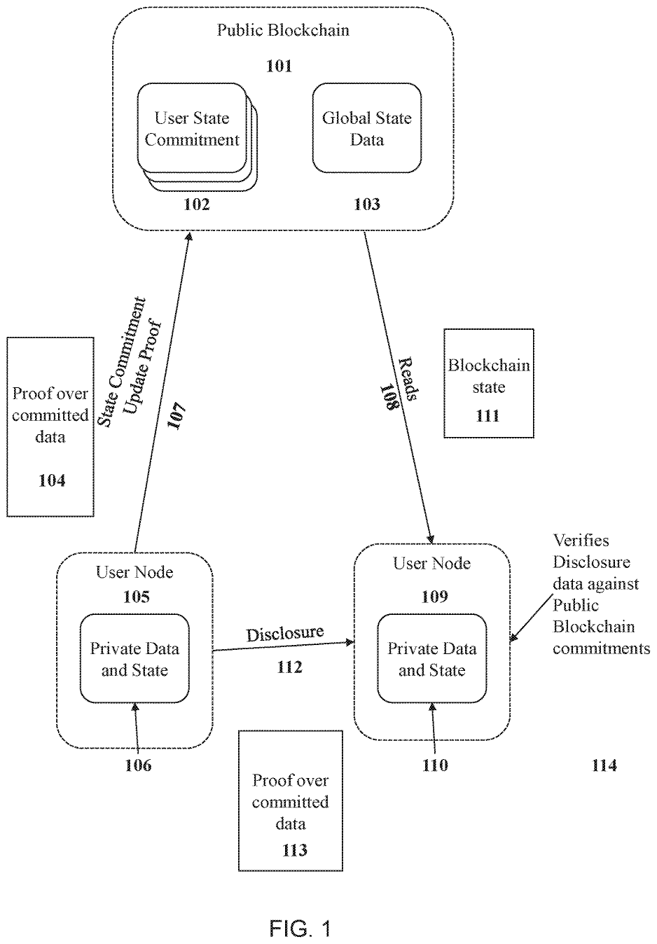

FIG. 1 shows an example of a global execution environment. The global execution environment implements methods and systems herein for managing private data, state commitments, and blockchain transactions within a blockchain network. It depicts the interactions between User Node 1805, Public Blockchain 101, and another User Node 109, forming a proof over committed data. This figure expands upon the earlier described process in FIG. 16, but with additional complexities in the relation between transactions and state.

Every user has a state, recorded in full on the user node 105. The user state may also be referred to as state of user account or user node. Data that is private to a respective user node may comprise: i) the totality of records and claims (entries, disclosures) made, ii) any additional metadata about the claims or their creation, iii) auxiliary data needed for creating proofs, iv) optionally additional framework, record and user state needed to enforce the rules of the framework, v) any other data that is necessary. In the illustrated example, the User Node 105 processes its private data, such as shipment records or material property claims. The state that results from this processing is then committed to the Public Blockchain 101, forming a User State Commitment 102. User Node 105 creates a State Commitment Update Proof 107 to update this commitment, which serves to verify that the new state follows the system rules and is derived from a previously verified state. As described elsewhere herein, the state is committed to by one singular cryptographic commitment to an authenticated data structure/Merkle tree representing the complete state, or multiple cryptographic commitments and nullifiers.

In some embodiments, data or information published to a public blockchain 101 may comprise i) publication of state commitments (which may result in an update to the global state agreed upon by the blockchain consensus), which consists of these state commitments, ii) the publication of the state-update is conditional on the verification of a zk-SNARK that the state update was the result of a valid state transition according to the global (i.e. non-framework specific) business logic, and iii) metadata encoded within the state commitment(s) which is about which particular methods allowed by the framework were used/which formally defined claim is being made. Which is enforced by the global business logic, and which informs the user verifiably what is being claimed.

As illustrated in FIG. 1, Public Blockchain 101 stores the User State Commitment 102 and Global State Data 103. This data is updated with any state modifications, keeping the blockchain information current and accurate.

To ensure privacy, the system uses Disclosures. These are additional proofs used to selectively reveal information about a state snapshot to other users. For example, if User A records information relevant to User B, User A may verify this information for User B with a Disclosure. This allows User B to reference and integrate this new data into their system and updates.

Data from Public Blockchain 101 may be transferred to User Node 109. User Node 109 holds its own Private Data and State 110, along with information relating to the Blockchain State 111.

User Node 105 sends a Disclosure 112 to User Node 109, which generates a Proof Over Committed Data. This Disclosure is then checked within User Node 109 against the Public Blockchain Commitments. This verification assures that the received data is valid, and that the state of the blockchain is consistent.

In some cases, data in the system may be managed per user Accounts. This is due to the importance of consistent and unique identities in lending value to claims and the necessity for the system to remain legible, especially for interoperability with other systems oriented around Decentralized Identifiers (DID) and Verifiable Credentials (VC) that rely on such persistent pseudonymous identities.

In the systems and methods described herein, accounts record their state confidentially in the form of cryptographic commitments and provide state updates using zk-SNARKs. This configuration results in a model comprised of parallel, confidential, and verifiable state machines with a shared global state. The model is analogous to a network of fault-tolerant machines that operate trusted software in a trusted environment while maintaining custody of private data. This feature enhances the security and confidentiality of the system.

### Recursive Proofs

In some embodiments all user state transitions in a given block, or even a given blockchain may be recursively aggregated into a single proof, such that the global state of the blockchain can be validated via a single proof When this includes the blockchain consensus, this is referred to as a succinct blockchain. This enables end-users to quickly verify claims.

In some embodiments, Disclosures may be interacted with and derived via recursive zk-SNARKs. In these embodiments a user may take a proof (Disclosure) about their or another user's state, or a multiplicity of proofs about a multiplicity of users' states and then use that to derive another claim (Disclosure) consistent with that, without updating their own user state. Records' state or entries are still committed/recorded on-chain, but the derivation of weaker claims, or the creation of collaborative inductive claims from Disclosures may occur off-chain. Recursive zk-SNARKs is used for the permissionless derivation of further claims/disclosures according to the framework rules, including collaborative inductive claims based on multiple disclosures, without performing a state transition (i.e., updating a state from a previous state).

### Transactions

In the systems and methods described herein, a transaction may be responsible for creating claims, which may be either entries or disclosures. When executed, a transaction validates that the exact claim being made is permissible, given the context and framework rules. It also carries out any side-effects, such as invalidations, entry settings, and claim creations, all in accordance with the framework rules. This feature ensures that all transactions adhere to the established rules, maintaining the integrity of the system.

### Approaches to Guaranteeing Recency of Data

In the systems and methods described herein, ensuring that the disclosed claims and their inductive dependencies remain up-to-date and valid may be advantageous, particularly for claims that rely on a credential that may be revoked, or for claims tied to the consumption or transfer of scarce assets that may be undone. While the task of ensuring data recency may be relatively straightforward in a public system, maintaining confidentiality and avoiding correlations between users in the system may add an element of complexity.

In the systems and methods described herein, the concept of staleness of disclosures is utilized. The status of a disclosure may change over time and its status needs to be periodically checked with respect to the current committed state of the disclosing party in the global execution environment. If a certain threshold time is exceeded, then the disclosure is considered stale and thus becomes suspicious, as the claim underlying it may have been superseded or revoked internally, and subsequent claims made by the user may contradict it. This staleness applies not only to the disclosure itself, but also to any disclosures used to substantiate the underlying claim. Hence, for the disclosure to be trustworthy and to avoid contradictory claims, it may help to periodically check a recursive definition of staleness, where a disclosure is considered stale if either its status has not been checked within the threshold interval or any disclosures used to substantiate it, directly or indirectly via internal intermediate claims, are also stale.

In other examples, within the systems and methods described herein, a concept of forced propagation via public, yet confidentiality preserving, revocation of claims may be utilized. However, this approach may carry higher confidentiality risks due to the reliance on computational assumptions in the cryptography involved and the helpful publicity of the revocation action, which may potentially make correlations between dependent claims evident through the timing of the propagating revocations. This also necessitates the concealment of the identity of the issuer of the revocations to mitigate potential correlations, resulting in ZCash-like private, spend-once, append-only state commitments rather than a mutable public user-to-state commitment map.

In the systems and methods described herein, the burden of regular synchronization with other users in the staleness-based approach may be alleviated with Framework-mandated freezing periods, after which records become immutable. A similar approach may be applied in the public revocation-based method to restrict the size of the set of disclosures whose revocation status needs to be checked against additions to the public revocation log. However, care may be taken not to allow freezing records in a way that permits non-transparent alterations of non-frozen dependencies of the claims of the frozen record. This becomes a non-issue if the nullifiers for all dependencies of a given claim, including indirect dependencies via intermediate claims, are known to those to whom the claim has been disclosed. In this case, revocation may not be censored by intermediaries, but this comes at the cost of a greater risk of correlation, as global identifiers for the dependencies of the claim are necessarily known.

### A Sketch of the System End-to-End

In the systems and methods disclosed herein, User Nodes may be operated directly by users or they may delegate this task to trusted parties. These User Nodes may be responsible for maintaining a record of a user's private state and any auxiliary data that may be helpful for generating zero-knowledge proofs, such as the intermediate nodes of authenticated data structures. Additionally, User Nodes may carry out the execution, aggregation, and verification of user transactions, and produce zero-knowledge proofs for peer-to-peer information exchange. This process effectively isolates private user data and may reveal it only on a need-to-know basis and solely at the level of detail deemed appropriate for the receiving party.

Users may contribute claims about subjects through transactions on the User Node, conforming to the schemas and logic of the associated Framework. The creation of claims and subjects, along with the linkage of subjects via claim references, may establish a canonical narrative about the subjects' various states and events over time. This narrative's interpretation is specified by the Framework. These transactions are ultimately verified by users via zk-SNARKs, which are submitted to a public blockchain as non-repudiable state update proofs, updating the on-chain state commitments. The zk-SNARKs may guarantee the integrity of the on-chain commitments and their consistency with the Framework definitions, and may also ensure that the recorded information represents a history of the subjects as well as a history of the claims made about them, including contradictions of previous claims by more recent ones.

User Nodes may also handle the exchange of data that underlies Disclosures, offering insights into aspects of the User's narrative. This includes both the current claims about events and the historical record of those claims, shared at a level of detail appropriate for the recipient. Disclosures may provide insights into the relative relationships between subjects or the global identities of subjects, as is suitable for the recipient. Given that the on-chain commitments, upon which Disclosures are based, are perfectly concealed, the underlying claims are shared while the correlation to the commitments is cryptographically proven. This approach may ensure the validity of the claims may be incorporated into the recipient user's Node's state update proof and may be leveraged in their own derivative claims and narrative construction. The structure of the on-chain commitments enables the verification and use of the Disclosure to substantiate further claims, without the User's state update proof needing to publicly reference the specific underlying data, subject identity, or original creator.

In the systems and methods disclosed herein, Frameworks are described in such a way that allows claims to be substantiated by the supporting statement itself, without the need to expose the underlying evidence. This maintains trust as the evidence is still known to exist. For example, in a scenario such as the child labour case illustrated in FIG. 2, it is sufficient to know that a certain certification or credential has been issued by a member of a set of designated issuers without needing to know which issuer specifically. For any given product, it may be adequate to demonstrate that all input products meet the definition of being free from child labour and that the processing facility holds the relevant credential, without having to identify the individual input products, their manufacturers, or the exact number of those products. The focus here is on showing adherence to the correct definition, and in cases where it is not, the extent of the discrepancy may be demonstrated without revealing specific details.

### Confidentiality of Data and Relationships

### Maintaining Confidentiality of Data and Relationships via Privileged Central Entities

In the systems and methods described herein, the design space of the system may contain various potential avenues for information leakage. While zero-knowledge proofs may play a role, they may not fully ensure anonymity, particularly in the context of supply chain participation. A notable risk involves the potential compromise of central entities entrusted with the task of maintaining the confidentiality of data and relationships within the system.

If a single entity holds all the system's information and its interconnections to ensure the system's integrity and operation, this entity may become a high-value target for compromise. This risk is especially pronounced given the inherent value that may be associated with the system's confidentiality.

To address this, the systems and methods disclosed herein are designed to maintain integrity and operate the system without relinquishing control of the underlying data. This approach distributes data among participants in such a way that they have access to exactly what they are permitted to know, no more, and the original data remains with the original provider unless it is disclosed to other users. This method disperses the value of the data across multiple lower-value targets in the system, rather than creating one central target for compromise. This mitigation strategy is particularly relevant when public proofs directly refer to data associated with other users' pseudonymous identities during the verification of transactions.

Public Proofs Referring Directly to Data Associated with Other Users' (Pseudonymous) Identities when Proving Transactions

One identifiable risk arises when public proofs necessitate public references to data associated with specific users. This may inadvertently not only reveal the immediate relations of the user publishing the proof but may also facilitate the creation of a graph mapping out all relationships in the dependency chain, subsequently highlighting the supply chain. Even with pseudonymity, this may decrease the level of uncertainty for adversarial or curious users about the identities involved and provide information about the quantity of distinct identities they interact with. For instance, identifying that a large proportion of assets were produced by a single entity may suggest a potential supply risk, which may be information that some parties may prefer to keep confidential.

To mitigate this risk, the systems and methods disclosed herein create public proofs with respect to a global state, which ultimately acts as an anonymity set over claims, rather than being tied to specific users or claims. This approach becomes particularly relevant when public proofs directly refer to another user's claim, which is not associated with their pseudonymous identity, during the verification of dependent claims.

Public Proofs Referring Directly to Another User's Claim, not Associated with their (Pseudonymous) Identity, when Proving Dependent Claims

Even when not associated with any identities, if global dependencies between claims are known and those claims may be identified, a user with a hypothesis about the identity of the creator of a claim in that dependency graph may be able to confirm this outside of the system, with the consent of the creator. This may potentially allow them to establish the claim's relation with the dependent claims, possibly revealing sensitive information such as the identities of higher-tier suppliers that intermediaries may have preferred to keep confidential.

To mitigate this risk, as previously mentioned, the systems and methods disclosed herein create proofs with respect to the global state, rather than specific claims. This approach is particularly relevant when public proofs directly refer to a claim during the process of invalidating, revoking, or updating it.

Public Proofs Referring Directly to a Claim when Invalidating/Revoking/Updating it

Another identifiable risk is that even if the dependent claims are not explicitly specified, revealing the identity of an invalidated, revoked, or updated claim may lead to the successive invalidation or updating of the chain of claims that depend on it. As this subsequent invalidation is public and correlated with the original invalidation, that is, one invalidation follows another, preferably in close proximity to minimize latency, it may potentially leak information about the dependencies between claims. If these claims are also linked to user identities, it may inadvertently disclose the relationships between users.

In response to this risk, the systems and methods disclosed herein implement an alternative mechanism to propagate updates based on the expiry of claims and active polling of users for a refreshed state. As it is a design goal for users to be able to determine if claims have been altered and to make it infeasible for a malicious user to suppress this information, this active approach flags expired claims as suspicious due to the omission of the updated state. This circumvents the need to mandate the publication of the ID of the updated claim upon changes to ensure knowledge of a claim's current state. More passive alternatives, such as broadcasting verifiably encrypted events readable only by designated users, may be permissible. However, they carry risks associated with publicly available encrypted data, which presents greater risks than peer-to-peer encrypted messaging with respect to store-then-decrypt attacks.

### Timing Correlations Between Transactions Issued by Related Entities

Another identifiable risk, albeit which may have weaker assumptions, arises from timing correlations between transactions issued by related entities. In an account-based system, entities whose transactions are interdependent risk being linked through timing correlations. For instance, if a customer confirms receipt of a shipment on their system, discloses this to their supplier, and the supplier then makes a linked reference to this in their own system, there is a risk, particularly if the process is automated and designed to minimize latency, that these consecutive transactions will become transparently associated with enough samples. This may happen even if the only information revealed is the identity of the issuer. As mentioned before, this may make it increasingly easy to infer supply chains and relationships.

To mitigate this risk, the systems and methods disclosed herein employ strategies consistent with a public account-based model, while also offering alternative mitigation strategies with varying trade-offs. Users may balance between latency, cost, and anonymity by issuing state updates in batches, rather than on a per-transaction basis. The frequency of these updates may not be associated with the transaction details and may be based on a regular interval or a policy solely focused on fees. However, this approach does involve a trade-off between cost and latency, leading to either frequent updates with a low batch size (or potentially empty updates) or high propagation latencies. This becomes especially relevant for deep, fast-moving supply chains. Alternatively, the risk may be mitigated using an anonymous transaction model, similar to Zcash, based on nullifiers. However, this offers reduced legibility and may face similar issues if participants' transactions are known to the adversary, which is not entirely implausible, especially in a store-then-decrypt scenario.

Onboarding Correlation with Supply-Chain Members

Another identifiable risk arises in scenarios where the system is self-contained and follows causality, implying that everything attested within the system must have had its logical preconditions attested to by a first party within the system prior to making a subsequent dependent claim. If the real-world identity of onboarded accounts is either public or may be inferred from provided disclosures, business relations between entities may potentially be inferred or at least deemed more likely by their joint presence on the system, even if the transactions themselves are confidential.

To mitigate this risk, the systems and methods disclosed herein accommodate transactions that may refer to subjects that are not uniquely identified within the system. Transactions may make attestations about foreign subjects or potentially interoperate with claims made in other systems as a form of evidence. Therefore, even without the presence of other members of a user's supply chain on the system, their presence is still reasonable. Given the privacy of transaction details, local claims, claims with off-system dependencies, and plain attestations are indistinguishable. This ensures a plausible alternative explanation for the presence of parties who may potentially act as a user's suppliers. Furthermore, it is feasible to mitigate the need to publicly disclose one's real-world identity associated with their account. Desirable properties like the uniqueness of the business associated with the account may be guaranteed while maintaining privacy through zero-knowledge proofs.

### State and Objects

The systems and methods described herein may comprise a hierarchical state that is organized and addressed at various levels such as User, User Framework, User Framework Record, and User Framework Record Framework. Users may transactionally create Records and the separate Entries of these Records. These systems and methods provide a range of approaches for precisely defining Entries within the system, establishing Disclosures in that context, and creating dependencies between claims.

### Entries as the Totality of Claims

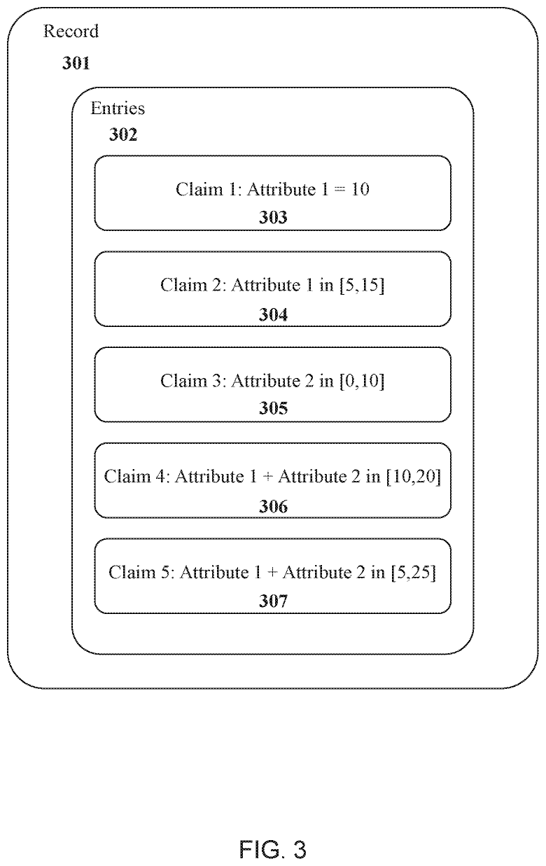

In the systems and methods disclosed herein, Entries (ENT1) may represent the totality of claims made about a specific subject, such as an asset, a virtual asset, an event, a recipe, and so forth, fixed at a specific point in time. These Entries are designed to be interdependent and may have the potential to invalidate each other (FIG. 3). In this model, Disclosures (DIS1) may be a selection of these Entries that are shared with another user. The process of invalidation and the enforcement of inter-claim consistency are managed through state mechanisms, separate from the set of Entries (INV1).

FIG. 3 shows an example of how Entries in a Record (301) are organized within the system, with each Entry corresponding to a different claim about certain attributes, in accordance with some embodiments. Specifically, this Record is composed of Entries (302), which includes Claim 1 (303) stating that Attribute 1 equals 10, Claim 2 (304) indicating that Attribute 1 falls within the range of 5 to 15, and Claim 3 (305) assigning Attribute 2 a range of 0 to 10. Further, Claim 4 (306) asserts that the sum of Attribute 1 and Attribute 2 is within the range of 10 to 20, while Claim 5 (307) expands this range to 5 to 25. This structure showcases the interdependency of Entries and their potential to invalidate one another, presenting the totality of claims about a subject Record.

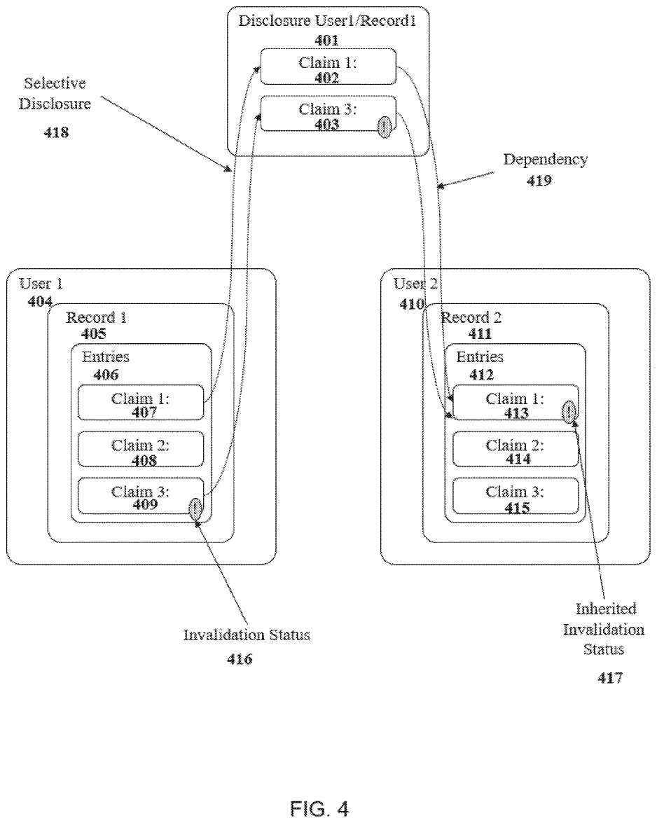

FIG. 4 shows an example of how Disclosures, which are selectively disclosed Entries, function within the system, particularly highlighting how their dependents inherit their validation status, in accordance with some embodiments. A Disclosure (401) pertaining to User1's Record1 selectively includes Claim 1 (402) and Claim 3 (403). User1 (404) has a Record 1 (405) with Entries (406) including Claim 1 (407), Claim 2 (408), and Claim 3 (409). Similarly, User 2 (410) also has a Record 2 (411) with Entries (412) including Claim 1 (413), Claim 2 (414), and Claim 3 (415). The figure highlights the Invalidation Status (416) associated with each claim and shows how this status is inherited (417) in the disclosed entries. This illustrates how selective disclosure (418) and dependency (419) operate in the system.

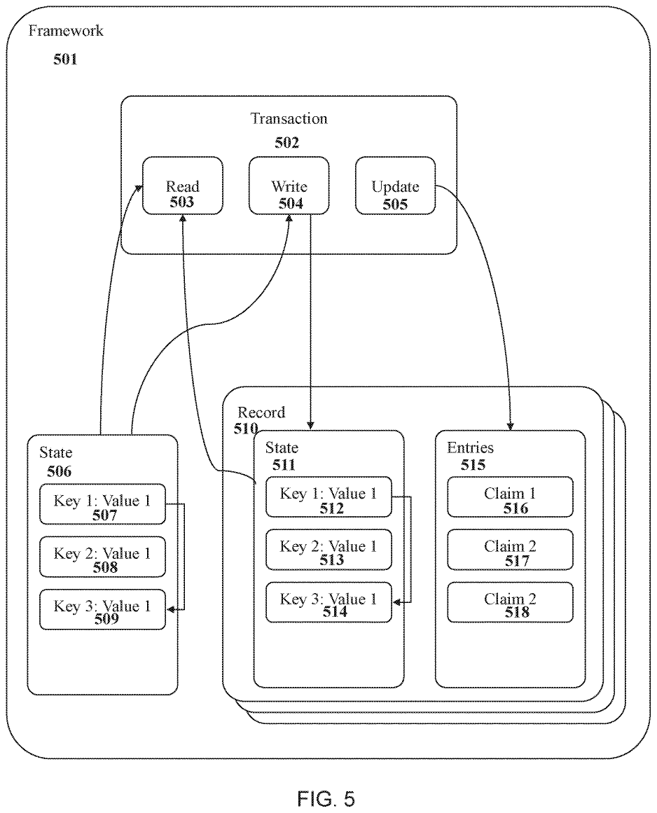

FIG. 5 shows an example of how Entries are created transactionally according to rules dependent on the record state and global state, as specified by the transaction methods of a Framework (501).

The transaction (502) may involve various operations such as read (503), write (504), and update (505). These operations affect the state (506) of the system, represented by different key-value pairs (507, 508, and 509).

The figure also illustrates a Record (510) having its own State (511) comprised of different key-value pairs (512, 513, and 514). Within this Record (510), there are multiple Entries (515), each representing a different claim (516, 517, and 518). The structure demonstrates the direct relationship between the transaction methods of the Framework and the resulting state of the system and its Records.

For Entries with logical dependencies on attributes of other local (i.e., created by the user) and non-local subjects/records, these are constrained by the validity status of local Entries (LDEP1.1) and non-local Disclosures. Alternatively, in LDEP1.2, Entries with logical dependencies on attributes of other local subjects/records are dependent on the state of those records, but non-local subjects/records are constrained by the validity status of Disclosures.

### Entries as the Most Constraining Claims

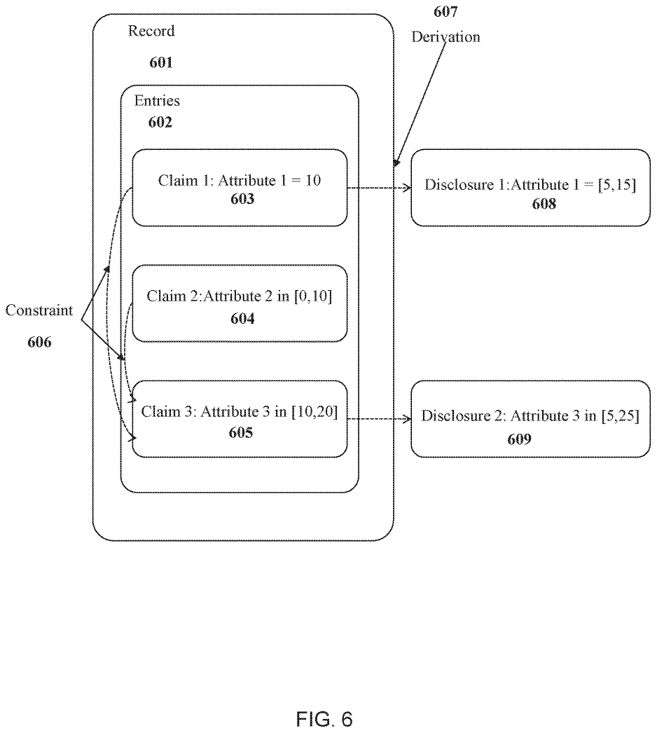

In the systems and methods disclosed herein, Entries (ENT2) may represent the basis claims, serving as the most constraining predicates, which are asserted about specific attributes of the subject Record. This Record may be an asset, a virtual asset, an event, a recipe, etc., fixed at a specific point in time. Disclosures may serve as predicates about specific attributes of the subject Record and the metadata associated with the Entry, such as when it was assigned and its history. As such, Disclosures and Entries are interchangeable in transactions as they are both predicates over the value of Attributes (FIG. 5). Alternatively, Disclosures may serve as predicates over several Entries, and the associated transaction details for the transaction in which the Entry was assigned, making Disclosures and Entries interchangeable in transactions (FIG. 6). Entries with logical dependencies on attributes of other local (i.e., created by the user) and non-local subjects/records may be constrained by Disclosures. On the other hand, Entries with logical dependencies on attributes of other local subjects/records may depend on the Entries of those records, but non-local subjects/records are constrained by the validity status of Disclosures.

FIG. 6 shows an example of how Entries, represented as the most constraining claims about an Attribute of a subject Record, and Disclosures, depicted as predicates over an Attribute as defined by its respective Entry, are organized within a Record (601) in the system, in accordance with some embodiments. The Entries (602) each correspond to a different claim, specifically Claim 1 (603) that states Attribute 1 equals 10, Claim 2 (604) that indicates Attribute 2 falls within the range of 0 to 10, and Claim 3 (605) that assigns Attribute 3 a range of 10 to 20. The figure also features a Constraint (606), represented by the equation {Attribute 3=Attribute 1+Attribute 2}, which creates a linkage between Claims 1, 2 and 3. Furthermore, there are two Disclosures (608, 609), each presenting a range of values for respective attributes. Disclosure 1 (608) presents a range of 5 to 15 for Attribute 1, while Disclosure 2 (609) gives a range of 5 to 25 for Attribute 3. A Derivation (607) further connects Claim 1 to Disclosure 1. This visual representation effectively illustrates the dynamic and interchangeable nature of Entries and Disclosures within the transactions of the system, demonstrating the interdependency and connectivity of claims.

### Constraints on Transactional Assignment of Entries

In the systems and methods disclosed herein, transactional assignment of Entries may follow certain constraints. Under the first scenario, transactions setting Entries are constrained by Entries and Disclosures, and invalidation may occur post-hoc when conditions are broken. Alternatively, transactions may be unconstrained with respect to what may be set. Instead, Disclosures themselves are used to check compliance with rules. Here, state is primarily used for maintaining history and data structure integrity, rather than for business logic. Disclosures prove double-spend protection by ensuring consistency between records, which is a requirement for scarcity and spending measures.

### Scarcity and Spending

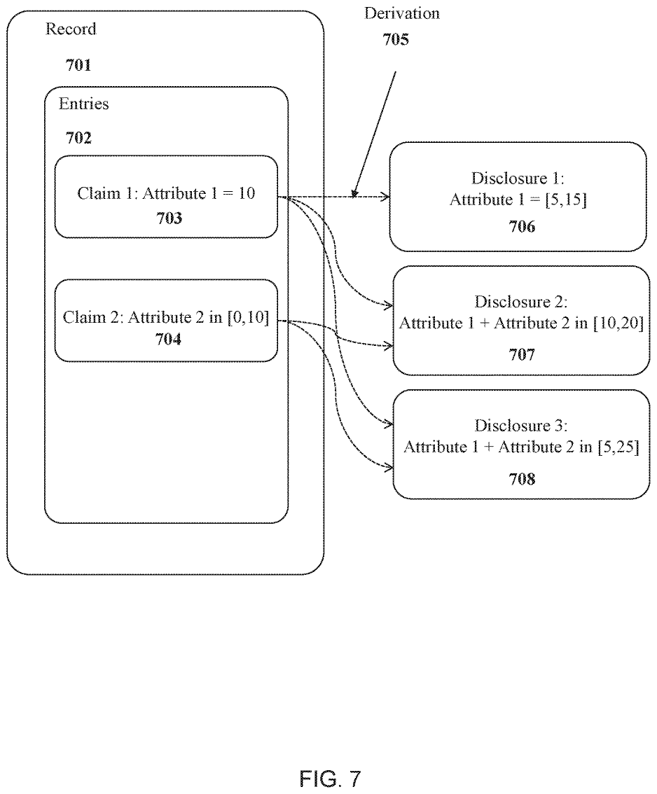

In the systems and methods disclosed herein, scarcity and spending may be managed via a UTXO-like spending model, referred to as Option 1. In this model, records representing assets may be referenced by records that consume them. These records reference each other reciprocally, while new assets mutually reference the consuming record, which represents, for instance, the residual balance of the scarce asset. The relationship between these output and input assets is regulated according to the framework constraints on the relationship between attributes of the referenced records (FIG. 7).

FIG. 7 shows an example of how Entries, as assertions about Attributes of a subject Record, and Disclosures, as predicates over Attributes constrained by Entries, are structured within a Record (701) and its associated Entries (702). Included in the figure are two claims: Claim 1 (703) stating that Attribute 1 equals 10, and Claim 2 (704) indicating that Attribute 2 falls within the range of 0 to 10. A Derivation (705) is also depicted and is connected to both Claim 1 and Disclosure 1 (706). The figure further shows three different Disclosures: Disclosure 1 (706) shows Attribute 1 falling within a range of 5 to 15; Disclosure 2 (707) indicates that the sum of Attribute 1 and Attribute 2 falls within the range of 10 to 20; and Disclosure 3 (708) states that the sum of Attribute 1 and Attribute 2 is within the range of 5 to 25. These visualizations effectively demonstrate the relationships and dependencies among Claims and Disclosures, and the structure of Entries within the Record.

In an alternative approach, herein referred to as the “State Mutating UTXO-like Model”, scarcity and spending are enforced using a model similar to UTXO. In this model, records representing assets may be referenced by records that consume them. This act of referencing in turn mutates a state that is used to track the context in which references may be made. The relationship between these output and input assets is regulated according to the framework constraints on the relationship between attributes of the referenced records. However, the act of spending is not considered an attribute of the record representing the consumed asset itself. In the “Transactional and Conditional References” variant of this approach, the references are made in a transactional and conditional manner, with the record of the asset being spent preventing further references in this manner. In the “Flexible Transactional References” variant, the references may be made transactionally or otherwise, with the referring record being recorded in the state. A subsequent reference may result in changes to the referring record, leading to a transparent invalidity of the previous spending claim.

### Balances—Ephemeral State Model

In another approach, herein referred to as the “Ephemeral State Model”, scarcity and spending are enforced through an ephemeral state that is mutated based on the claims made by the user. This restricts claims to be made in a manner that is both transactional and effectual. The state has the capacity to record a remaining balance for an asset according to the ways in which the asset has been claimed to have been used.

### Balances—Inductive Claims Over Logs

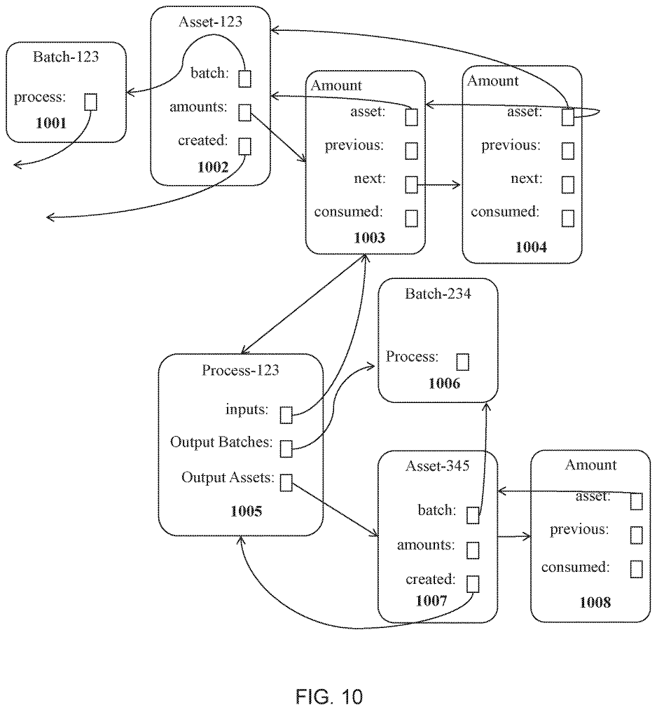

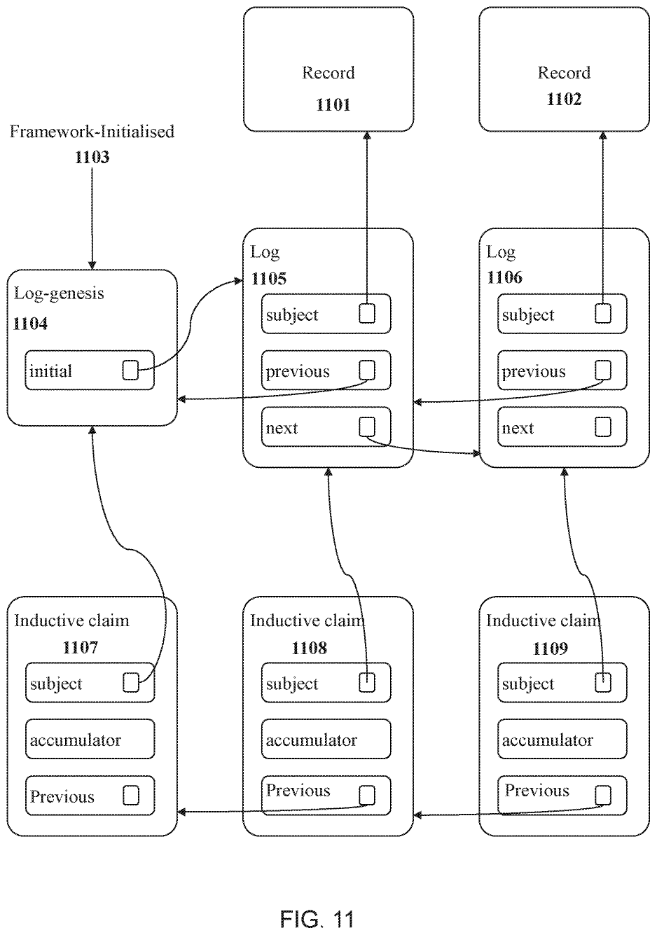

In yet another approach, referred to herein as the “Inductive Claims Over Logs Model”, scarcity may be implemented as inductive claims over logs. This is accomplished using mutually referenced records, analogous to a doubly-linked list, starting from a predefined or default genesis log. An additional mutual reference exists between the subjects and the log entry records. This log is equivalent to maintaining a list of spends of the asset, thus modifying an indexed remaining balance. Unlike in the UTXO model, this approach reflects that the asset remains unchanged apart from the amount remaining (FIG. 10).

FIG. 10 shows an example of implementing spending rules that update the remaining amount of an asset using the mutual referencing pattern within the system. The illustration depicts the processing of a batch (Batch-123) including an asset (Asset-123) and demonstrates how the amount records may mimic a mutable remaining balance of an asset, despite records reflecting a static (albeit updateable) narrative about a subject. Inductive predicates over the amount log may assure that the remaining amount is consistent with the historical narrative, in accordance with some embodiments. This asset has a defined batch and amounts, and a record of when it was created (1002). It is linked to an Amount, which includes information about the asset, the previous amount, the next amount, and when it was consumed (1003). This is further linked to another Amount, showcasing the asset, previous amount, next amount, and consumption details (1004). The figure also shows a process (Process-123) with inputs and output batches, leading to output assets (1005). Another batch (Batch-234) is shown in process (1006), leading to another asset (Asset-345) with its own batch, amounts, creation record (1007), and linked Amount detailing the asset, previous amount, and when it was consumed (1008).

### Spending of Non-Local Assets

Non-local assets, which are assets represented by records created by another user that become the subject of a record representing their transfer of ownership, also necessitate the preservation of scarcity. This may be accomplished through various means:

In an approach herein referred to as “User Direct Claims”, the principles of Scarcity and Spending are employed, but with the system state extended and claims created to encapsulate User, Framework, Record, User, and Framework. This implies that a user may directly assert claims about other users' records as a part of their own user state. This may involve recording the receipt in the state as part of a transaction, thus prohibiting further receipts of the same asset, or by generating mutual references via their own Entries for the foreign Record illustrating the transfer.

Alternatively, in the “Mutual Referencing Records Model”, mutual referencing of records is used in combination with the aforementioned methods. In this case, the attested receipt of the asset represented in a recipient's record is referenced by the sender of the asset in the record documenting the transfer. This enables the recipient, upon disclosure, to demonstrate that both records agree.

### Global Claims

Global claims may also be managed within the systems and methods disclosed herein. In one approach, referred to as the “Inductive Claims Over Logs Model”, global claims may be implemented as inductive claims over logs. This is accomplished using mutually referenced records analogous to a doubly linked list, starting from a predefined or default genesis log. An additional mutual reference exists between the subjects (for example, processes at a facility or shipments of material) and the log entry records (FIG. 11).

FIG. 11 shows a high-level schematic example of how logs of records are organized to mimic indexing using the mutual referencing pattern within the system. The illustration depicts two Records (1101 and 1102) and a Framework-Initialised log (1103) that organizes and orders otherwise separate records. The genesis log entry designates the “official” log, and the inductive claim records act as the index. These may calculate, for instance, the running warehouse or unit occupancy, or the incoming and outgoing material over some predetermined bookkeeping period, to aid in mass-balance calculations, in accordance with some embodiments. The log begins with a Log-genesis (1104), which includes an ‘initial’ field. This is followed by two additional Logs (1105 and 1106) each containing fields for ‘subject’, ‘previous’, and ‘next’. The figure also includes three Inductive Claims (1107, 1108, and 1109), each with fields for ‘subject’, ‘accumulator’, and ‘previous’. This structure demonstrates how global claims may be implemented as inductive claims over logs.

### Inductively Proved Predicates Over Stateful Logs

In another approach, referred to as the “Inductively Proved Predicates Over Logs Model”, global claims may be implemented as inductively proved predicates over logs constructed in state as a result of transactionally set effectual claims or record construction. This method involves creating a logical structure where each claim or record builds upon previous ones, thereby proving consistency and adherence to specified constraints.

### State-Based Implementation:

In a different approach, referred to as the “State-Based Implementation Model”, global claims may be implemented as an aspect of the state, which is mutated as a result of transactionally set effectual claims or record construction. This approach leverages the state to track and validate global claims, ensuring that any modifications reflect the overall consistency and validity of the claims made by the user.

### Merkle Tree/Cryptographic Accumulator Mapping:

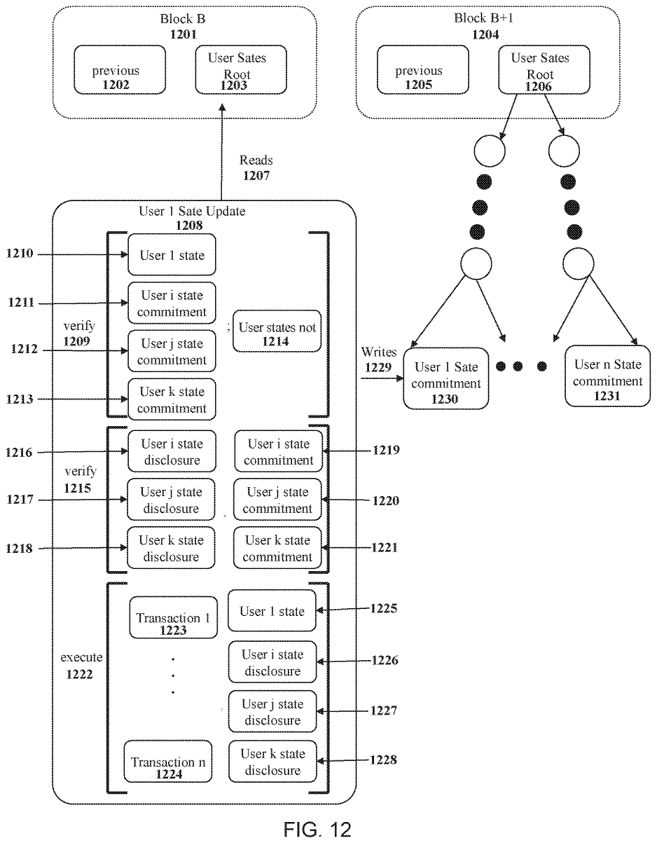

In a strategy referred to as the “Merkle Tree/Cryptographic Accumulator Mapping Model”, user state updates are managed by maintaining a global public user-to-state root commitment mapping. This is accomplished using a Merkle tree or cryptographic accumulator. Updates occur in parallel between blocks, with each update referring only to the previous committed state of other users, ensuring they commute. Instead of propagating updates and invalidations publicly and being forced by transaction/state-update logic, which may be problematic in this state model where transaction issuers are publicly identified, the validation status of a claim is understood to be dynamic and requires regular checking (FIG. 12).

FIG. 12 shows an example of the state update process in the user state root mapping approach within the system. This includes the verification of inclusion of user state commitments in the previous mapping and disclosures in the private user state commitments, visualizing the “Merkle Tree/Cryptographic Accumulator Mapping Model,” in accordance with some embodiments.

The figure displays two blocks, Block B (1201) and Block B+1 (1204), each with a reference to the previous block (1202 and 1205) and a User States Root (1203 and 1206). The diagram represents the reading of User 1 State Update (1208), which is verified (1209) against User 1 state (1210) along with User i, j, k state commitments (1211, 1212, 1213). It also displays the non-verification of other User states (1214). Disclosures from User i, j, k states (1216, 1217, 1218) are verified and committed (1219, 1220, 1221). The execution (1222) of Transactions 1 to n (1223, 1224) is depicted, and the resulting User 1 state (1225) is shown along with User i, j, k state disclosures (1226, 1227, 1228). Finally, the writing of User 1 State commitment (1230) and User n State commitment (1231) is illustrated.

In a sub-option of the “Merkle Tree/Cryptographic Accumulator Mapping Model”, herein referred to as “Timestamped Disclosures with Framework Defined Expiry”, communicated Disclosures, or committed Record versions or committed Entries against which Disclosures are proven, carry a timestamp (the timestamp of the block against which their existence is proven) and a Framework-defined expiry. After this expiry, they become stale. This staleness is inherited by dependents substantiated by them, as staleness is recursively defined such that a Disclosure is stale if it has exceeded its expiry or if its dependents are stale.

In another variant of this model, referred to as “Recorded Set of Revoked Disclosures”, a committed set of revoked Disclosures, or Record versions, or Entries is recorded at each state update. The status of communicated Disclosures may be proven by a set intersection proof with the set of communicated Disclosures known not to have been revoked previously, and the set of revoked Disclosures.

In managing the revocation status of each individual communicated Disclosure, continual checking may be required, which may necessitate work on the part of the prover at each check proportional to the total number of communicated Disclosures. To limit this growth, Frameworks may define a procedure or time requirement for freezing records to prevent subsequent updates as appropriate.

In another variant, referred to as “Indexed Communications”, communications of disclosures, updates, and revocations may be indexed by the prover and the recipient in an Incrementally Verifiable Computation (IVC). This allows it to be proven over each period that the transactions since the previous update of Disclosure statuses resulted in a specific log of revoked Disclosures only, among the set of communicated Disclosures. This requires work dependent only on the number of transactions in the interval and the number of users to which claims are communicated. It is worth noting that these strategies are mostly relevant for users who intend to derive claims from disclosures, rather than for end customers, for example.

Epochs with Prunable Nullifier Sets:

Another strategy, herein referred to as “Epochs with Prunable Nullifier Sets”, employs epochs with distinct prunable nullifier sets. This approach allows for low latency within epochs for referencing, while maintaining minimal growth of the nullifier set. The method utilizes Zcash-style note commitments for user state roots.

There are several variants of this strategy. In the “Opt-in Epochs with Forced End-states” variant, epochs are opted into and force end-states. The “Opt-in Epochs without End-state Withdrawals” variant allows for opting into epochs but does not enforce end-state withdrawals, which may disrupt other users' referencing transactions or updates. Finally, the “State-channel-like Epochs” variant allows for epochs similar to state-channels, wherein other users may anonymously submit valid states if the initial user does not.

### Semi-Prunable Nullifier Sets:

In privacy-preserving systems such as Zcash, nullifiers, also used in the systems and methods disclosed herein, may play a role in preventing double-spending of notes while keeping the specific spent note concealed. When a note commitment is spent in systems like Zcash, a nullifier is generated in a manner that is unique to the spent note and yet untraceable back to it. This nullifier is then added to a nullifier set, which is a public list of all spent notes. This ensures that once a note is spent, it may not be spent again without disclosing which specific note was spent. The nullifier concept may be extended for the invalidation or updating of the state in general.

A similar system, as outlined in the systems and methods disclosed herein, may be utilized to ensure append-only Record/Entry versioning and to prevent ambiguity over a user's current state. This may be achieved by privately invalidating the previous state or records without revealing the associated user. However, one potential challenge with nullifiers is that the nullifier set may grow linearly with the number of transactions or state updates. This may become an issue in a system used over an extended period with a substantial number of users, as the nullifier set may become significantly large, leading to increased storage and computational requirements.

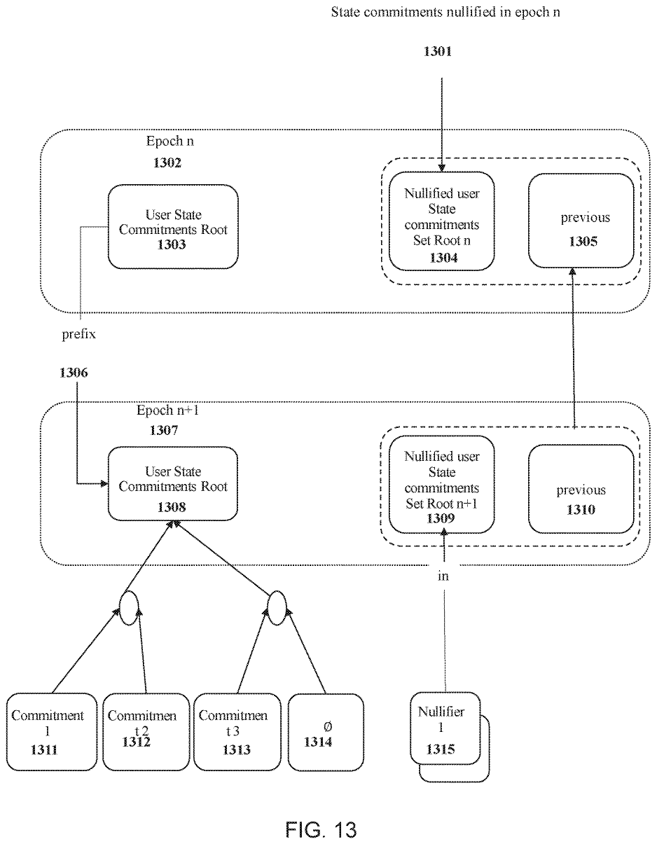

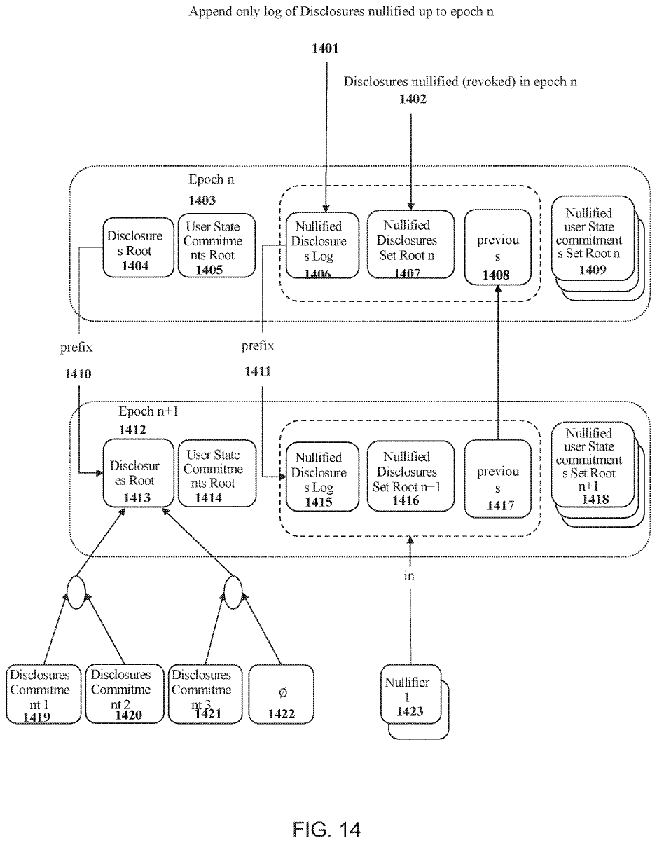

In another approach, referred to as the “Epoch-based Data Availability Model”, epochs are also utilized, but primarily to reduce data availability assumptions. This method employs Zcash-style note commitments and nullifiers for updating user state roots, ensuring data availability only for recent epochs. Otherwise, users must store witness and nullifier set paths. In this model, note commitments represent full user states rather than assets or aspects of global state (FIG. 13).

FIG. 13 shows an example of the structure of User State Commitments in a ZCash-like model within the system. The illustration depicts state commitments nullified in epoch n (1301) and epoch n+1 (1307). The User State Commitments are added to the User State Commitments Tree, which is append-only. When the user's state is updated, the state commitment is added to the current epoch's Nullified User State Commitments set in a ZCash-style manner, in accordance with some embodiments.

Each epoch contains a User State Commitments Root (1303, 1308) and a Nullified User State Commitments Set Root (1304, 1309), linked to the previous state (1305, 1310) and prefix (1306). The figure also shows several Commitments (1311, 1312, 1313) and a Nullifier (1315), with an empty set (0) depicted as well (1314). This illustrates how user state roots are updated using note commitments and nullifiers, ensuring data availability for recent epochs.

In another approach, referred to as the “Nullifier-Based State Updates Model”, forced propagation of invalidations is permitted without allowing significant correlation of the relationship between users and records. This is achieved through nullifier-based state updates which enable the revocation or invalidation of historical disclosures via the forced publication of a nullifier. This nullifier is constructed to be unique and non-identifying of the revoked disclosure in the absence of the concealed information, but is nonetheless identifiable to those who have been given access to the disclosure. The nullifier used in state updates is distinct in that the user's local state is sufficient to prevent repeat revocation, making non-membership proofs unnecessary (FIG. 14).

FIG. 14 shows an example of an augmented version of the model depicted in FIG. 12. It includes a nullified disclosure log within the system. The illustration shows an append-only log of Disclosures nullified up to epoch n (1401), and Disclosures nullified or revoked in epoch n (1402). Disclosures are globally identified by their commitment in the Disclosures root and additional concealed information. They may be invalidated as a side effect of the state-update logic, by adding the respective nullifier to the Nullified Disclosures log, in accordance with some embodiments.

Each epoch, such as epoch n (1403) and epoch n+1 (1412), contains a Disclosures Root (1404, 1413), a User State Commitments Root (1405, 1414), a Nullified Disclosures Log (1406, 1415), a Nullified Disclosures Set Root (1407, 1416), and a Nullified User State Commitments Set Root (1409, 1418), all linked to the previous state (1408, 1417) and prefix (1410, 1411). The figure also illustrates several Disclosures Commitments (1419, 1420, 1421) and a Nullifier (1423), with an empty set (Ø) also depicted (1422). This highlights how nullifier-based state updates may permit revocation or invalidation of historical disclosures.

### Communication of Claims

In the systems and methods disclosed herein, claims are communicated externally in the form of Disclosures. In one approach, referred to as the “Zero Knowledge Proof Over Cryptographic Commitment Model”, Disclosures are a zero-knowledge proof over a cryptographic commitment to a version of a record and its entries. These are communicated peer-to-peer and the statement of the disclosure proof may be based on different elements.

In the “Record Commitment as Proof Subject” variant, a cryptographic commitment of the record is made to a public bulletin board and has an expiry. This commitment serves as the proof subject. The validity of the revocation or contradiction status of the record must be re-checked after this expiry.

In the “User State Commitment as Proof Subject” variant, a cryptographic commitment of the user state, including the record and its entries, is recorded and has an expiry. This commitment serves as the proof subject. The validity of the revocation or contradiction status of the record must be re-checked with respect to a more recent user state after the expiry.

In another approach, referred to as the “Derived Claim Model”, Disclosures are a claim derived from a record, proven, and registered as part of a user's state transition.

In the “Disclosure Commitment as Proof Subject” variant, a cryptographic commitment of the disclosure is made to a public bulletin board as part of the state transition and has an expiry. This commitment acts as the proof subject. After this expiry, the validity of the revocation or contradiction status of the disclosure must be re-checked.

In the “User State and Disclosure Commitment as Proof Subject” variant, a cryptographic commitment of the user state, including the record and its entries, and the disclosure is recorded and has an expiry. This commitment serves as the proof subject. The validity of the revocation or contradiction status of the record must be re-checked with respect to a more recent user state after the expiry.

### Mutual Referencing Pattern

The mutual referencing pattern disclosed herein is an approach that effectively prevents double-spending of assets in scenarios without a global user-state. This pattern involves a consuming process that creates a reference to a consumed asset, and reciprocally, the asset generates a reference back to the consuming process, resulting in a one-to-one correspondence. These systems and methods allow for a consistent spending narrative to be verified in a read-only manner. If proof of consistency is missing, it is flagged as suspect, potentially indicating unsubstantiated claims or foul play. Thus, the disclosed systems and methods not only enforce accurate asset spending but also uphold the overall integrity and reliability of the system.

The systems and methods disclosed herein involve maintaining a history of previously claimed values of attributes, such as the locations where an asset was spent or the inputs consumed in a process. This history provides flexibility in managing errors in data entry, and also flags the occurrence of such errors, thereby promoting correct data entry. In the mutual referencing pattern, the suspicion of errors operates bidirectionally. For instance, if an asset is claimed to be used as an input after it has been spent elsewhere, the claim becomes publicly invalidated and is considered suspect. Similarly, if the assets used as inputs do not match prior claims, such as in the case of local depictions of foreign assets before their global identity was known, such deviations may be identified. However, these systems and methods allow for substantiation of consistency in earlier claims despite these discrepancies.

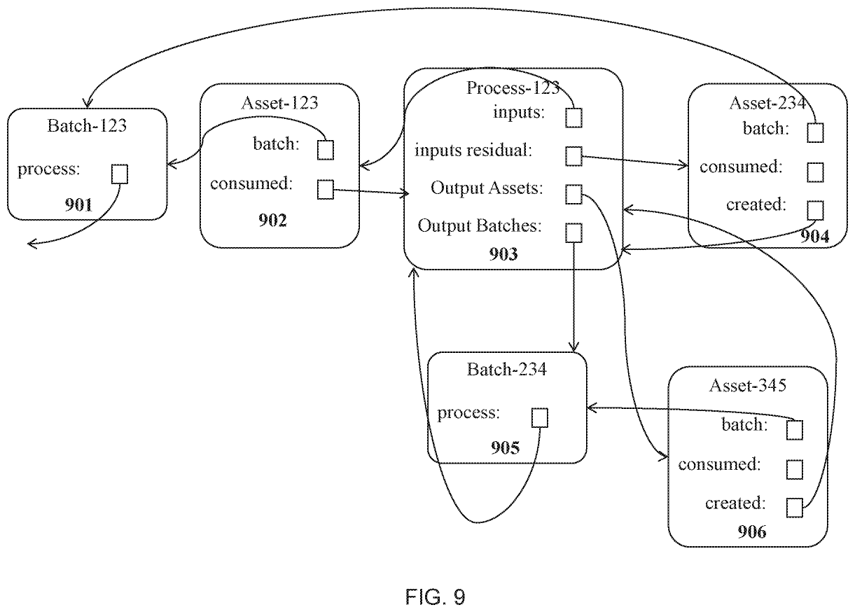

The systems and methods disclosed herein demonstrate that the mutual referencing pattern may be generalized to support any form of depiction of evolving history or mutable state over time. This is illustrated in the Inductive Claims over Logs section (FIG. 9).

FIG. 9 shows an example of the implementation of Unspent Transaction Output (UTXO)-like spending using the mutual referencing pattern within the system. The illustration, which is simplified for clarity, depicts the creation of an Asset record representing the remaining unconsumed input and another record representing the output of a process, in accordance with some embodiments.

The figure shows a chain of assets (Asset-123, Asset-234, and Asset-345) and associated processes (Process-123 and Process-901). Each asset is linked to a batch (Batch-123 and Batch-234), which records the process (901 and 905) that consumed or created the asset (referenced as ‘consumed’ and ‘created’). The process is also linked to ‘inputs’ and ‘inputs residual’, denoting the assets used and remaining, respectively. Furthermore, ‘Output Assets’ and ‘Output Batches’ links depict the results of the processes. Each link in this chain demonstrates the mutual referencing pattern, ensuring a complete and verifiable record of the history and changes in state over time.

### Accounts

The systems and methods disclosed herein allow for flexibility in account management and authentication. While left generic, the use of on-chain state and zk-SNARKs enables more complex approaches, such as key rotation, multi-signature schemes, and social recovery. Furthermore, these systems and methods allow for the fragmentation of accounts into sub-accounts, providing a more top-down management structure, which may be advantageous in larger organizations. In these instances, user nodes may aggregate data from multiple sub-accounts, allowing for further fragmentation and management of sensitive data. Enforcement of Disclosure Policies

While the systems and methods disclosed herein recognize that controlling the forwarding or sharing of copyable information outside of the system may be challenging, an alternative approach is proposed. These systems and methods encourage the demonstration of compliance with the disclosure policy set by the disclosee, particularly regarding what elements of the disclosure may be shared with other parties. Furthermore, within the system, it is suggested to limit the use of claims outside the permitted domain in the creation of derivative claims. Therefore, while controlling the sharing of information in violation of the policy may be complex, such shared information that is outside the system may not carry the same level of verifiability, as users are encouraged to verify compliance with disclosure policies within the system.

### Collaboration Over Joint Data Vs Exchanged Claims

In the context of the systems and methods disclosed herein, strategies purely based on the exchange of zero-knowledge proofs may have limitations. These limitations arise from the differing levels of information that parties are willing to disclose to intermediaries, privileged downstream parties, or as part of large-scale aggregate information that is less identifying.

Despite these limitations, committing to original data does not restrict collaboration within this system. An exchange of disclosures involving verifiably homomorphically encrypted versions of the committed data may be effectively facilitated within this system.

Additionally, the use of collaborative zk-SNARKs through multi-party computation is also supported by the system. This is a distinctive approach from decentralized private computation that relies on distributed ledgers and recursive proofs, offering an alternative means for secure and private collaboration within the system.

Approaches to Interoperability with W3C DID and VC

W3C Verifiable Credentials (VCs) primarily comprise signed documents, but solely verifying the signature may not encapsulate all information, as a “Verifiable Data Registry” such as a blockchain or DNS records, may also be used for the resolution of the subject and issuer's Decentralized Identifier (DID). This may assist in associating the public key with the identities and addressing revocation. Consequently, within the context of the disclosed systems and methods, various approaches may be utilized for enhancing interoperability. These approaches may encompass the use of a Framework-approved bridge or on-chain client, notarization by Framework-approved notaries, or presenting the Verifiable Data Registry against which the claim has been verified.

### On-Chain Client

As part of the Framework or on a global scale, but with approval from the Framework, there may be an implementation of a client for the relevant Verifiable Data Registry. For example, an Ethereum light client may be used for Ethereum-based DIDs, or a DNS registry for DNS-based DIDs. The specifics of these implementations are not determined here, but may vary. They may range from a simple multi-signature mechanism or notarization by a collection of Framework-approved parties operating traditional clients, to comprehensive light clients, or even to more complex fraud-proof based approaches.

### Notarization of Individual VC Presentations

In the disclosed systems and methods, approved notaries may have the capability to independently verify the relevant Verifiable Credentials (VCs) or their presentations. These notaries may then notarize this verification event within the system. Additionally, these notaries may possess the ability to revoke their attestation may the credential itself be revoked, adding another layer of flexibility and responsiveness to the status changes of VCs in the system.

### Presentation of Unambiguous Verifiable Data Registry State

As part of the disclosed systems and methods, the state or block of the Verifiable Data Registry, or the relevant Bridge, may be presented alongside the claim. Verification of the claim may then be carried out within the system with respect to this state or block. In this scenario, there is no specific canonical bridge or client. Instead, it is up to the claim recipient to determine their level of trust. To avoid fingerprinting, an anonymity set over bridges may be presented, or a less detailed presentation of the block may be used. This approach may help ensure that users or assets are not identified by unique block numbers or by the choice of bridge.

### Constraining Entries and Disclosures: How Framework Business Logic is Expressed

### Approach 1: Forward Propagation of Predicates via Attribute Definitions DAG

Attributes of Records are specified by Frameworks, including their definitions or constraints in terms of other attributes, for example, total cumulative greenhouse gas emissions (tcGHG) in CO2e of a process may be defined as the sum of the tcGHG for each input to the process, and the total in-house greenhouse gas emissions (tGHG) for the process, and the tGHG may be defined as the weighted sum (weighted by the appropriate conversion factors) of the breakdown of the greenhouse gas emissions of the process.

Similar constraints may be defined for other attributes, such as the ratio of inputs and outputs being consistent with recipe conversion factors, constraining that input and output assets may be of the models defined in the process recipe, processes not exceeding the maximum capacity of the associated machinery. Amounts remaining of consumed assets being consistent with the difference of the original and consumed amounts.

These constraints are propagated forward over the dependency DAG, so that the validity of later Entries are contingent upon them. For instance, assigning 10T CO2e to the tcGHG of a process record, and then later assigning 11T CO2e to the tGHG may invalidate the 10T CO2e. Or assigning the same as an upper bound for tGHG may again invalidate the tcGHG assignment.

### GLOSSARY

(Cryptographic) Commitment Scheme: A process Comm(input, blinding) for producing a value from an input intended to be concealed, and a blinding factor: another value used to perform the concealment, where it is infeasible to convincingly claim that the input value was anything other than what was originally used to produce the output. Thus allowing the output value to represent a binding commitment to the input value, without revealing the input itself.

Authenticated Data Structure: An “Authenticated Data Structure” refers to a data structure in the disclosed systems and methods where operations may be verified without needing access to the entire data structure itself. In this context, it often refers to conventional data structures wherein pointers are replaced with hashes of the referenced nodes. The entire data structure may be referred to by the hash of a root node, which allows a pathway of hash-based references to all other nodes. This configuration allows for efficient and secure data verification, contributing to the overall integrity and reliability of the systems and methods disclosed herein.

Hashchain: A type of authenticated data structure representing a log, which may be efficiently appended to, but where proving the inclusion of older values depends on how deep they are into the log. It is analogous to a linked list, using hashes in place of pointers.

Merkle Tree: A type of authenticated data structure representing an array of values (leaves) of fixed length where the value at a particular index may be proven efficiently, and writing to indices may be proven efficiently. It is analogous to a binary tree, using hashes in place of pointers.

Sparse Merkle Tree: A type of Merkle Tree extended with a notion of an empty leaf, representing sparse data structures.

Merkle Map: A map or set data structure implemented as a (typically) sparse Merkle Tree, where leaf indices derived from a collision resistant hash of the key (in the sense of a Map data structure), may allow for an unbounded keyspace.

Indexed Merkle Tree: A way of implementing a Merkle Map without corresponding the leaf indices to Map keys, but rather using the leaves to store nodes of a key-sorted linked list of key-value pairs.

(Merkle) Root: The hash of the root node of a Merkle Tree or other authenticated data structure. Any singular value that is able to represent an entire data structure.

Cryptographic Accumulator: Implementation of a set data structure with efficiently verifiable inclusion and membership proofs and a small commitment value (the accumulator)

Zero Knowledge Proof: A protocol by which a party (the Prover) may convince another party (the Verifier) of the truth of a statement without revealing anything of the underlying private witness (evidence) to the truth of that statement. The protocol is such that the probability of the Prover convincing the Verifier of a false statement is negligible (i.e. it is sound). It is typically useful to think of the statement as the correct execution of a computer program. Which is to say you are proving that “If you run Program on my secret data (witness) you get Output” without revealing what the secret data actually is.

zk-SNARK: A type of non-interactive Zero-Knowledge proof where the proof given to the verifier is much smaller than the witness and may be checked much more quickly, there are computational hardness assumptions underlying the soundness, and the prover must know the private witness.

In the context of the disclosed systems and methods, a “Proof” refers to a substantiation of a specific statement or assertion. This substantiation may take the form of a zero-knowledge succinct non-interactive argument of knowledge (zk-SNARK), or a witness satisfying a statement. This may provide evidence for the validity or truth of the assertion, maintaining the confidentiality of the underlying information and ensuring the integrity of the data within the system.

“Proof Composition” in the context of the disclosed systems and methods refers to the process of producing a single proof by combining multiple proofs. This allows for more complex assertions or validations to be substantiated effectively by amalgamating several pieces of evidence or proofs into one comprehensive proof This technique may enhance the efficiency and clarity of proof verification in the system.

A “Recursive/Inductive Proof” refers to a type of proof within the disclosed systems and methods that is defined recursively. It implies that a portion of the statement being proved involves verifying a similar instance of itself. For instance, a recursive proof of the execution of a virtual machine may be a statement asserting, “Either the virtual machine is being initialized to output an initial state, or there is a valid instance of this proof outputting a certain state, and the execution is continuing from that state to the next step outputting a new state.” This recursive or inductive nature of the proof enables complex computations and operations to be validated effectively within the systems and methods disclosed herein.

“Incrementally Verifiable Computation” within the context of the disclosed systems and methods is a concept that allows for the verification of computations in an incremental manner. This is similar to the previously mentioned example of a virtual machine. In such a setup, computations or operations are divided into smaller, manageable parts and each part is verified independently. This incremental approach facilitates the validation of complex computations and improves the efficiency of the system.

Fully Homomorphic Encryption (FHE): Encryption schemes that allow untrusted parties to perform computations on encrypted data to produce an encrypted output that may be decrypted by parties possessing the decryption key.

(Secure) Multiparty Computation ((S)MPC): Protocols that allow parties to perform computations over data distributed between them without the parties learning the data that they did not originally possess. This is distinct from zero knowledge proofs in that parties may compute over the joint data, not only what they know themselves to reach the result.

Threshold (Fully Homomorphic) Encryption/Signatures: Cryptographic schemes that require a certain threshold of participation from some fixed set of parties in order to execute. For instance, needing above a certain number of partial decryptions to fully decrypt a ciphertext, or above a certain number of parties to participate in some joint signing ceremony to spend some commonly owned assets.

Consensus Mechanism: A protocol for getting a computer network to agree on some value.

Blockchain: A distributed system organizing consensus around an append only ledger.

Block: Analogous to a page in the ledger, timestamping in a blockchain is at the level of blocks.

Public Blockchain: A blockchain whose consensus mechanism allows public participation and public verification, whose security is built around no single malicious entity controlling a certain percentage of a scarce resource (in proof of stake: cryptocurrency, in proof of work: compute).

Succinct Blockchain: A blockchain, such as Mina, whose transactions and consensus may be verified entirely via a single zk-SNARK.

“Commit to”, in the context of the disclosed systems and methods, refers to the act of either publishing a cryptographic commitment to a blockchain or creating and sharing such a commitment on a peer-to-peer basis. Typically, it most commonly refers to the act of making a public commitment on a blockchain. This cryptographic commitment serves as a guarantee or binding pledge regarding a specific piece of data or transaction, ensuring its integrity and authenticity within the systems and methods disclosed herein.

Nonce: Number used only once like a counter, or a uniformly sampled (pseudo) random value.

UTXO-model: A model of transactions, used in bitcoin, where transactions over assets spend assets that are unspent and create new unspent assets for use in later transactions, as opposed to maintaining accounts with balances of assets. UTXO stands for Unspent Transaction Output.

In the context of the disclosed systems and methods, a “Nullifier” is a term used in two distinct ways. Initially, as per its usage in platforms like ZCash and Semaphore, a Nullifier is a value intrinsically linked to a resource that may only be consumed once. This Nullifier is published publicly at the point of resource consumption to prevent reuse. In some instances, the computation of this Nullifier is intentionally designed to be infeasible for anyone other than the owner of the resource.

The alternate usage of “Nullifier” in these systems and methods refers to a value that is publicly published to facilitate an undeniable revocation or invalidation process. In this context, the published Nullifier is specifically designed to only identify the resource being revoked to those parties who were originally aware of it, thereby preserving confidentiality while ensuring the integrity of the revocation process.

The term “ZCash-like” in the context of the systems and methods disclosed herein, pertains to transaction models that bear resemblance to the one utilized in ZCash. This involves an append-only set of commitments, which may be “spent” or utilized just once by users through a transaction. This transaction involves a zero-knowledge succinct non-interactive argument of knowledge (zk-SNARK) that proves a statement akin to “I know of a commitment in SET whose nullifier is NULLIFIER”. This model ensures confidentiality by not revealing the specific commitment utilized.

Following the transaction, the nullifier is added to a nullifier set, which effectively prevents the commitment from being reused in future transactions. There may also be a proof asserting that the nullifier is not a part of the nullifier set, but this generally depends on whether the system is a traditional blockchain, in which transactions are verified through naive re-execution, or a zk-Rollup or succinct blockchain where transactions are verified via zk-SNARKs.

In the transaction models in the disclosed systems and methods, the commitments have the capacity to represent not just assets, but also mutable private states. For example, the concealment may focus on the modification of a particular aspect of the state, rather than on which asset was spent. This range of representation suggests the adaptability of the disclosed systems and methods in managing and tracking various types of commitments.

An “Epoch” in the context of the disclosed systems and methods refers to a specific, parameterized time period around which the system is organized. This time period may not necessarily represent the most detailed or granular level of time measurement within the system. However, it holds significance in structuring and coordinating the system's operations and functions, effectively serving as a key time unit for organizing transactions, updates, or other time-sensitive processes within the system.

A “Credential” within the context of the disclosed systems and methods refers to a document or evidence that is issued to a subject by an identified entity. This Credential typically serves as evidence or proof for a particular claim or assertion. It validates the claim and provides authenticity, acting as a source of trust within the system. It is used to substantiate statements and facilitate the verification process within the disclosed systems and methods.

“Self-Sovereignty,” in the context of the systems and methods disclosed herein, refers to the principle where user data, especially private witness data or evidence, remains under the possession and control of the users themselves. Instead of relying on a central trusted operator, this principle emphasizes user autonomy and control over their own data. This ensures the privacy of users' information and minimizes the risk of centralized data breaches or unauthorized access.

A “Decentralized Identifier” or “DID” is a standard from the World Wide Web Consortium (W3C) for defining resolvable identities without needing a centralized operator. This standard, referred to as Decentralized Identifiers (DIDs) v1.0, provides a framework for creating unique, persistent, and verifiable identifiers that are not reliant on a central registry, entity or intermediary. This decentralization ensures user control over digital identities, enhancing privacy and security within the systems and methods disclosed herein.

VC: Verifiable Credentials, a w3c standard for credentials issued by trusted parties about a given subject with cryptographically verifiable issuance and revocation.

“Selective Disclosure,” in the context of the disclosed systems and methods, refers to the practice of revealing a specific subset of a collection of values to another party based on one's discretion. This typically applies to a collection of values that are jointly signed or attested to, or organized into a single document. Much like covering up certain fields in a passport when presenting it, selective disclosure allows users to control the amount and type of information that is shared, enhancing privacy and data security within the system. This feature enables the flexibility to share only relevant or necessary information, while keeping other data confidential.

### Computing Systems

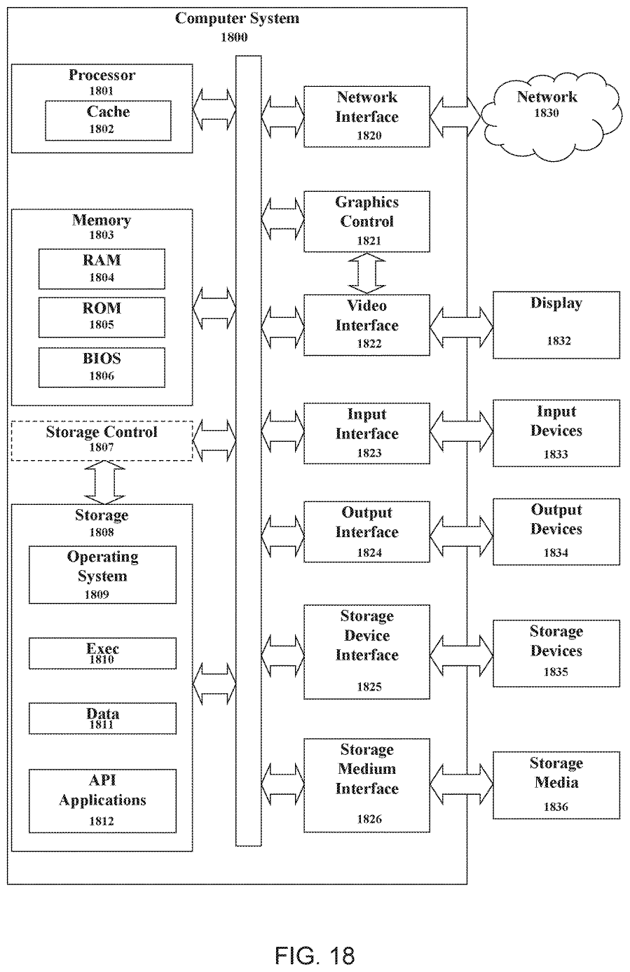

Referring to FIG. 18, a block diagram is shown depicting an exemplary machine that includes a computer system 1800 (e.g., a processing or computing system) within which a set of instructions may execute for causing a device to perform or execute any one or more of the aspects and/or methodologies of the present disclosure. The components in FIG. 18 are examples only and do not limit the scope of use or functionality of any hardware, software, embedded logic component, or a combination of two or more such components implementing particular embodiments.

Computer system 1800 may include one or more processors 1801, a memory 1803, and a storage 1808 that communicate with each other, and with other components, via a bus 1840. The bus 1840 may also link a display 1832, one or more input devices 1833 (which may, for example, include a keypad, a keyboard, a mouse, a stylus, etc.), one or more output devices 1834, one or more storage devices 1835, and various tangible storage media 1836. All of these elements may interface directly or via one or more interfaces or adaptors to the bus 1840. For instance, the various tangible storage media 1836 may interface with the bus 1840 via storage medium interface 1826. Computer system 1800 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 1800 includes one or more processor(s) 1801 (e.g., central processing units (CPUs) or general purpose graphics processing units (GPGPUs)) that carry out functions. Processor(s) 1801 optionally contains a cache memory unit 1802 for temporary local storage of instructions, data, or computer addresses. Processor(s) 1801 are configured to assist in execution of computer readable instructions. Computer system 1800 may provide functionality for the components depicted in FIG. 18 as a result of the processor(s) 1801 executing non-transitory, processor-executable instructions embodied in one or more tangible computer-readable storage media, such as memory 1803, storage 1808, storage devices 1835, and/or storage medium 1836. The computer-readable media may store software that implements particular embodiments, and processor(s) 1801 may execute the software. Memory 1803 may read the software from one or more other computer-readable media (such as mass storage device(s) 1835, 1836) or from one or more other sources through a suitable interface, such as network interface 1820. The software may cause processor(s) 1801 to carry out one or more processes or one or more steps of one or more processes described or illustrated herein. Carrying out such processes or steps may include defining data structures stored in memory 1803 and modifying the data structures as directed by the software.

The memory 1803 may include various components (e.g., machine readable media) including, but not limited to, a random access memory component (e.g., RAM 1804) (e.g., static RAM (SRAM), dynamic RAM (DRAM), ferroelectric random access memory (FRAM), phase-change random access memory (PRAM), etc.), a read-only memory component (e.g., ROM 105), and any combinations thereof. ROM 1805 may act to communicate data and instructions unidirectionally to processor(s) 1801, and RAM 1804 may act to communicate data and instructions bidirectionally with processor(s) 1801. ROM 1805 and RAM 1804 may include any suitable tangible computer-readable media described below. In one example, a basic input/output system 1806 (BIOS), including basic routines that help to transfer information between elements within computer system 100, such as during start-up, may be stored in the memory 1803.

Fixed storage 1808 is connected bidirectionally to processor(s) 1801, optionally through storage control unit 1807. Fixed storage 1808 provides additional data storage capacity and may also include any suitable tangible computer-readable media described herein. Storage 1808 may be used to store operating system 1809, executable(s) 1810, data 1811, applications 1812 (application programs), and the like. Storage 1808 may also include an optical disk drive, a solid-state memory device (e.g., flash-based systems), or a combination of any of the above. Information in storage 1808 may, in appropriate cases, be incorporated as virtual memory in memory 1803.

In one example, storage device(s) 1835 may be removably interfaced with computer system 100 (e.g., via an external port connector (not shown)) via a storage device interface 1825. Particularly, storage device(s) 1835 and an associated machine-readable medium may provide non-volatile and/or volatile storage of machine-readable instructions, data structures, program modules, and/or other data for the computer system 1800. In one example, software may reside, completely or partially, within a machine-readable medium on storage device(s) 1835. In another example, software may reside, completely or partially, within processor(s) 1801.

Bus 1840 connects a wide variety of subsystems. Herein, reference to a bus may encompass one or more digital signal lines serving a common function, where appropriate. Bus 1840 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1800 may also include an input device 1833. In one example, a user of computer system 1800 may enter commands and/or other information into computer system 1800 via input device(s) 1833. Examples of an input device(s) 1833 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 1833 may be interfaced to bus 1840 via any of a variety of input interfaces 1823 (e.g., input interface 1823) including, but not limited to, serial, parallel, game port, USB, FIREWIRE, THUNDERBOLT, or any combination of the above.

In particular embodiments, when computer system 1800 is connected to network 1830, computer system 1800 may communicate with other devices, specifically mobile devices and enterprise systems, distributed computing systems, cloud storage systems, cloud computing systems, and the like, connected to network 1830. Communications to and from computer system 1800 may be sent through network interface 1820. For example, network interface 1820 may receive incoming communications (such as requests or responses from other devices) in the form of one or more packets (such as Internet Protocol (IP) packets) from network 1830, and computer system 1800 may store the incoming communications in memory 1803 for processing. Computer system 1800 may similarly store outgoing communications (such as requests or responses to other devices) in the form of one or more packets in memory 1803 and communicated to network 1830 from network interface 1820. Processor(s) 1801 may access these communication packets stored in memory 1803 for processing.

Examples of the network interface 1820 include, but are not limited to, a network interface card, a modem, and any combination thereof. Examples of a network 1830 or network segment 1830 include, but are not limited to, a distributed computing system, a cloud computing system, a wide area network (WAN) (e.g., the Internet, an enterprise network), a local area network (LAN) (e.g., a network associated with an office, a building, a campus, or other relatively small geographic space), a telephone network, a direct connection between two computing devices, a peer-to-peer network, and any combinations thereof. A network, such as network 1830, may employ a wired and/or a wireless mode of communication. In general, any network topology may be used.

Information and data may be displayed through a display 1832. Examples of a display 1832 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 1832 may interface to the processor(s) 1801, memory 1803, and fixed storage 1808, as well as other devices, such as input device(s) 1833, via the bus 1840. The display 1832 is linked to the bus 1840 via a video interface 1822, and transport of data between the display 1832 and the bus 1840 may be controlled via the graphics control 1821. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 1832, computer system 1800 may include one or more other peripheral output devices 1834 including, but not limited to, an audio speaker, a printer, a storage device, and any combinations thereof. Such peripheral output devices may be connected to the bus 1840 via an output interface 1824. Examples of an output interface 1824 include, but are not limited to, a serial port, a parallel connection, a USB port, a FIREWIRE port, a THUNDERBOLT port, and any combinations thereof.

In addition or as an alternative, computer system 1800 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate range (FPGA) or other programmable logic device, discrete gate or transistor logic, discrete hardware components, or any combination thereof configured to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor may read information from, and write information to, the storage medium. In the alternative, the storage medium may be helpful to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, cloud computing platforms, distributed computing platforms, server clusters, server computers, desktop computers, laptop computers, notebook computers, sub-notebook computers, netbook computers, and netpad computers.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research in Motion® BlackBerry OS®, Google® Android®, Microsoft® Windows Phone® OS, Microsoft® Windows Mobile® OS, Linux®, and Palm® WebOS®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Programs

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, which perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of information. In various embodiments, suitable databases include, by way of non-limiting examples, relational databases, non-relational databases, object oriented databases, object databases, entity-relationship model databases, associative databases, XML databases, disclosure oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

1. A computer-implemented method for producing and sharing verifiable information while preserving anonymity and privacy, the computer-implemented method comprising:
creating, by a user at a user node, one or more claims about a subject, wherein the one or more claims are constrained by a constraint system associated with the subject;
updating, at the user node, a state related to the user node or a user account based on the one or more claims, wherein the state related to the user node or the user account comprises private data that is stored on the user node and not shared publicly;
updating or creating a cryptographic state commitment for validating proofs of the updated state, wherein the cryptographic state commitment is associated pseudonymously or anonymously with the user and is recorded on a blockchain, and wherein validating proofs of the updated state comprises proofing that updating the state is a valid state transition from a previous state or proofing a validity of the one or more claims about the state underlying the cryptographic state commitment; and
constructing a Zero-Knowledge proof that attests to a validity of the updated state without revealing the state, wherein the Zero-Knowledge proof ensures that the one or more claims adhere to the constraint system and a previous state.

2. The computer-implemented method of claim 1, wherein the constraint system is a framework comprising one or more predefined rules constraining a formal expression of the one or more claims.

3. The computer-implemented method of claim 1, wherein the one or more claims comprise a collaborative inductive claim.

4. The computer-implemented method of claim 3, wherein the collaborative inductive claim references one or more other claims.

5. The computer-implemented method of claim 4, wherein the one or more other claims are created by another user.

6. The computer-implemented method of claim 4, wherein the one or more other claims are verified by the user node against a cryptographic state commitment associated with the another user that is recorded on the blockchain.

7. The computer-implemented method of claim 4, wherein the one or more referenced claims are predicates over a process by which the one or more claims were created and/or metadata.

8. The computer-implemented method of claim 1, wherein the Zero-Knowledge proof is zero-knowledge succinct non-interactive arguments of knowledge (zk-SNARKs).

9. The computer-implemented method of claim 1, wherein the blockchain is a public blockchain.

10. The computer-implemented method of claim 1, wherein the cryptographic state commitment associated with the user on the blockchain is stored utilizing an authenticated data structure.

11. The computer-implemented method of claim 10, wherein the cryptographic state commitment associated with the user is identified by an index of a leaf node of a Merkle Tree.

12. The computer-implemented method of claim 11, wherein updating the cryptographic state commitment associated with the user comprises maintaining a root commitment mapping using the Merkle tree or a cryptographic accumulator.

13. The computer-implemented method of claim 12, wherein the root commitment is used as an input to a proof for publicly verifying the one or more claims created by the user and the updated state.

14. The computer-implemented method of claim 10, wherein the user is identified by a key in an indexed Merkle Tree or by a key of the authenticated data structure implementing a map structure.

15. The computer-implemented method of claim 1, wherein the one or more claims about the subject are verifiable by verifying an authenticity or a compliance with the constraint system.

16. (canceled)

17. The computer-implemented method of claim 1, wherein the one or more claims about the subject are in the form of entries of a record.

18. The computer-implemented method of claim 17, wherein the entries store information about one or more attributes of the subject.

19. The computer-implemented method of claim 18, wherein the one or more attributes are defined by one or more predefined rules of the constraint system.

20. The computer-implemented method of claim 19, wherein the one or more attributes are constrained by a forward propagation of predicates through an attribute definition Directed Acyclic Graph (DAG).

21. The computer-implemented method of claim 19, wherein the one or more attributes are constrained by propagation of constraints through a dependency DAG.

22.-53. (canceled)
